(19) United States
(12) Patent Application Publication
(10) Pub. No.: US 2018/0283882 A1
(43) Pub. Date: Oct. 4, 2018

(54) LOCATION-BASED SERVICES SYSTEM AND METHOD THEREFOR

(71) Applicant: Appropolis Inc., Calgary (CA)

(72) Inventors: Zhe HE, Calgary (CA); You LI, Calgary (CA); Yuqi LI, Calgary (CA)

(21) Appl. No.: 15/945,628

(22) Filed: Apr. 4, 2018

Related U.S. Application Data
(60) Provisional application No. 62/481,489, filed on Apr. 4, 2017.

(51) Int. Cl. G01C 21/32; G01C 21/34; G01C 21/36; G01C 21/20

(52) U.S. Cl. CPC G01C 21/32; G01C 21/3407; G01C 21/3446; G01C 21/206; G01C 21/3605

(57) ABSTRACT

A system and method efficiently integrate a variety of available signals and sensors such as wireless signals, inertial sensors, image sensors, and/or the like, for robust navigation solutions in various environments while simultaneously generating and updating a location-based service (LBS) feature map.

### CROSS-REFERENCE TO RELATED APPLICATIONS

This application claims the benefit of U.S. Provisional Patent Application Ser. No. 62/481,489, filed Apr. 04, 2017, the content of which is incorporated herein by reference in its entirety.

### FIELD OF THE DISCLOSURE

The present disclosure relates generally to a navigation method and system and in particular, to a navigation method and system using a location-based services map for high-performance navigation.

### BACKGROUND

Location-based services (LBS) based on Global Navigation Satellite Systems (GNSS) have been among the most important technologies developed during recent decades. Examples of GNSS systems include the Global Positioning System (GPS) of the U.S.A., GLONASS systems of Russia, the Doppler Orbitography and Radio-positioning Integrated by Satellite (DORIS) of France, the Galileo system of the European Union, and the BeiDou system of China.

Such systems generally use time-of-arrival (TOA) of satellite signals for object positioning and can provide absolute navigation solutions globally under relatively good signal conditions. For example, in GPS navigation systems, the object locations are usually provided as coordinates in the World Geodetic System 1984 (WGS84) which is an earth-centered, earth-fixed terrestrial reference system for position and vector referencing. In GLONASS systems, the object locations are usually provided as coordinates in PZ90 which is a geodetic datum defining an earth coordinate system.

Assisted GNSS systems use known ephemeris and navigation data bits to extended coherent/non-coherent integration time for improving the acquisition sensitivity, instead of decoding data from weak signals. Assisted GNSS systems also implement coarse-time navigation solution for further extending the positioning capability in degraded scenarios. However, in some difficult environments, the signal acquisition or detection in assisted GNSS systems experience many challenges such as extremely high error rates, code phase observations with large noise, observations dominated by outliers, and/or the like, due to threshold effects with low signal-to-noise-ratio (SNR).

The above-described TOA-based navigation systems are thus unreliable in many situations. Scenario-dependent patterns may be used to improve the positioning performance of the TOA-based navigation systems. It is also known that there exist some statistical patterns or features in adverse environments such as environment-dependent channel propagation parameters which may be useful for further enhancing navigation performances in systems using GNSS only or systems combining GNSS with other navigation means.

Other object positioning or navigation systems are also available. For example, navigation systems using a combination of sensors have been developed for indoor/outdoor object tracking. Such navigation systems combine the data collected by a plurality of sensors such as cameras, inertial measurement units (IMUs), received signal strength indicators (RSSIs) that measure wireless signal strength received from one or more reference wireless transmitters, magnetometers, barometers, and the like, to determine the position of a movable object.

Among these systems, inertial navigation systems (INS) use inertial devices such as IMUs for positioning and navigation, and are standalone and self-contained navigation systems unaffected by multipath. The strapdown mechanization method is a standard way to compute the navigation solution. A detailed description of the strapdown mechanization method can be found in the academic paper entitled “Inertial navigation systems for mobile robots” by B. Barshan and H. F. Durrant-Whyte, and published in IEEE Transactions on Robotics and Automation, Volume 11, Number 3, Page 328-342, Jun. 1995.

The inherent limitation for INS is the initial alignment and sensor errors, and the initial alignment and sensor error modelling directly impacts the performance of INS. For example, without updates from other system (for example, a GPS system), sensor errors such as bias, drifts, scale factors and/or the like may quickly accumulate, and subsequently cause the navigation solution to drift very quickly. The cost and quality of IMU also directly affect the quality of the navigation solution. For most massive-market applications, low-cost IMU data processing is still challenging. It is known that scenario-dependent constraints such as non-holonomic constraints for vehicles, are useful. However, in complex environments where sensor errors cannot be reliably estimated, the navigation solutions will still drift quickly.

Simultaneous localization and mapping (SLAM) methods for mapping and navigation which simultaneously tracking moving objects in a site and building or updating a map of the site, are known. The SLAM methods may be effective in many indoor scenarios especially when successful loop closure can be detected. As those skilled in the art understand, the term “loop closure” herein refers to the detection of a previously-visited location or alternatively, that an object has returned to a previously-visited location.

A problem of conventional SLAM methods is that vision or image sensors are easily affected by lighting or illumination in some environments. The number of observations also greatly limits the application of using conventional SLAM methods.

Wireless signal RSSI is often used as an observation. Path-loss model or fingerprinting algorithms use the RSSI measurements (or simply denoted as the received signal strength (RSS); the terms “RSSI” and “RSS” may be used interchangeably hereinafter) to perform the positioning/localization in all kinds of scenarios.

FIG. 1 shows a traditional sensor data processing which uses sensor observations 20 to build dynamic models or measurement models 24 based on the types 22 of sensor observations 20, and then fuses the dynamic or measurement models by an estimation technique such as a Kalman filter or a particle filter, to obtain the solution 26.

For example, available IMU data (22A) may be processed by an INS and/or pedestrian dead reckoning (PDR) method for position/velocity/attitude updates (24A). Available wireless RSSI observations (22B) may be processed through fingerprinting or multilateration for position/velocity/attitude updates (24B). Available magnetometer data (22C) may be processed for providing magnetic heading updates (24C1) or magnetic matching based position updates (24C2).

Available spatial structure data (22D) may provide position/attitude updates (24D1 and 24D2) if a link is selected. Features extracted from available Red-Green-Blue-and-Depth (RGB-D) images or point clouds (22E1) may be used for position/attitude updates (24E1) or loop closure detection (24E2) when a loop closure is detected. If the movable object 108 is a vehicle (22F), vehicle motion model constraints such as non-holonomic constraints may be used for vehicle motion model update (24F). If the movable object 108 is a device movable with a pedestrian (22G), pedestrian motion model updates may be applied (24G).

Hence, there is a need of using a plurality of sensors to provide robust navigation solution with an integrated navigation system that make optimal use of various available signals and sensors such as wireless signals, inertial sensors, image sensors, and/or the like, such that devices, including devices with limited functionalities, can achieve satisfactory positioning performance.

### SUMMARY

The present disclosure relates to systems, methods, and devices that efficiently integrate a variety of available signals and sensors such as wireless signals, inertial sensors, image sensors, and/or the like, for robust navigation solutions in various environments, and simultaneously generate and update a location-based service (LBS) feature map.

The LBS feature map encodes LBS features with spatial structure of the environments while taking into account the distribution of raw sensor observations or parametric models. The LBS feature map may be used to provide improved location services to a device comprising suitable sensors such as accelerometers, gyroscopes, magnetometers, image sensors, and/or the like.

The devices may transmit or receive wireless signals such as BLUETOOTH® or WI-FI® signals (BLUETOOTH is a registered trademark of Bluetooth Sig. Inc., Kirkland, Wash., USA, WI-FI is a registered trademark of Wi-Fi Alliance, Austin, Tex., USA) and may use Internet-of-things (IoT) signals such LoRa or NBIoT signals. The sensors of the devices may or may not be calibrated or aligned, and the device or an object carrying the device may be stationary or moving. In some embodiments, the system and method disclosed herein may work with an absolute navigation system such as global navigation satellite systems (GNSS). In some other embodiments, the system and method may work without any absolute navigation systems. The systems and methods disclosed herein can provide improved indoor/outdoor seamless navigation solutions.

Embodiments disclosed herein relate to methods for generating and/or updating the LBS feature map using a plurality of sensor data encoded with the spatial structure and observation variability. These methods may include:
A method using buffered navigation solutions to add relative constraints. As is shown in FIG. 14, the enhanced navigation solution buffers sequences of navigation solution states (with consideration of sensor model parameters or data processing parameters from the LBS map and the corresponding covariance matrices), and adds relative constraints to a graph-based optimizer.
A method for generating reliable locations using a plurality of sensor data and relative constraints for an enhanced navigation solution.
A method for generating the LBS feature map with sensor data, navigation solution and spatial information.
A method for re-evaluating and updating the LBS feature values based on constraints and the availability of sensor data.
A method for storing spatial-dependent and/or device-dependent LBS features in the LBS feature map for improved location services. For example, combining a low-cost inertial measurement unit (IMU) with the LBS feature map may significantly improve the navigation solution as shown in FIGS. 19A and 19B, in which a hallway spatial structure easily adds relative constraints to buffered navigation solutions which may be also used for estimating the vertical gyro in-run bias.
A method for using LBS feature map to apply spatial constraints for IMU, wireless data and/or image sensor data.
A method for merging or aligning multiple regional LBS feature maps to generate a global LBS feature map.

According to one aspect of this disclosure, there is provided a system for tracking a movable object in a site. The method comprises: a plurality of sensors movable with the movable object; a memory; and at least one processing structure functionally coupled to the plurality of sensors and the memory. The at least one processing structure is configured for: collecting sensor data from the a plurality of sensors; obtaining one or more observations based on the collected sensor data, said one or more observations spatially distributed over the site; retrieving a portion of the LBS features from a LBS feature map of the site, the LBS feature map stored in the memory and comprising a plurality of LBS features each associated with a location in the site; and generating a first navigation solution for tracking the movable object at least based on the one or more observations and the retrieved LBS features, said first navigation solution comprising a determined navigation path of the movable object and parameters related to the motion of the movable object. The plurality of LBS features in the LBS feature map are spatially indexed.

In some embodiments, the plurality of LBS features in the LBS feature map is also indexed by the types thereof.

In some embodiments, the LBS feature map comprises at least one of an image parametric model, an IMU error model, a motion dynamic constraint model, and a wireless data model.

In some embodiments, the at least one processing structure is further configured for: obtaining one or more navigation conditions based on the one or more observations; and said retrieving the portion of the LBS features from the LBS feature map comprises determining the portion of the LBS features in the LBS feature map based on the one or more navigation conditions.

In some embodiments, the at least one processing structure is further configured for: building a raw LBS feature map based on the observations; extracting a graph of the site based on the observations, the graph comprising a plurality of nodes and a plurality of links, each of the plurality of links connecting two of the plurality of nodes; and for each of the plurality of links, interpolating the link to obtain the coordinates of a plurality of interpolated points on the link between the two nodes connecting the link, according to a predefined compression level, determining LBS features related to the points on the interpolated link from the raw LBS feature map, the points on the interpolated link comprising the plurality of interpolated points and the two nodes connecting the link, and adding the determined LBS features into a compressed LBS feature map.

In some embodiments, the at least one processing structure is further configured for: extracting a spatial structure of the site based on the observations; calculating a statistic distribution of the observations over the site; adjusting the spatial structure based on at least the statistic distribution of the observations; fusing at least the adjusted spatial structure and the observation distribution for obtaining updated LBS features; and associating the updated LBS features with respective locations for updating the LBS feature map.

In some embodiments, the at least one processing structure is further configured for: simplifying the spatial structure into a skeleton, the skeleton being represented by a graph comprising a plurality of nodes and a plurality of links, each of the plurality of links connecting two of the plurality of nodes. Said adjusting the spatial structure based on at least the statistic distribution of the observations comprises: adjusting the graph based on at least the statistic distribution of the observations.

In some embodiments, said graph is a Voronoi graph.

In some embodiments, said adjusting the spatial structure based on at least the statistic distribution of the observations comprises at least one of: merging two or more of the plurality of nodes in a first area of the site and removing the links therebetween if the number of samples of the observations in the first area is smaller than a first predefined number-threshold; and adding one or more new nodes and links in a second area if the number of samples of the observations in the second area is greater than a second predefined number-threshold.

In some embodiments, the at least one processing structure is further configured for: adjusting the spatial structure based on geographical relationships between the nodes and links.

In some embodiments, said adjusting the spatial structure based on the geographical relationships between the nodes and links comprises at least one of: merging two or more of the plurality of links located within a predefined link-distance threshold; cleaning one or more of the plurality of links with a length thereof shorter than a predefined length threshold; merging two or more nodes located within a predefined node-distance threshold; and projecting one or more nodes to one or more of the plurality of links at a distance thereto shorter than a predefined node-distance threshold.

In some embodiments, said generating the first navigation solution comprises: generating a second navigation solution and storing the second navigation solution in a buffer of the memory; and if there exist more than one second navigation solutions in the buffer, applying a set of relative constraints to the more than one second navigation solutions for generating the first navigation solution for tracking the movable object.

In some embodiments, the at least one processing structure is further configured for updating the LBS feature map using the first navigation solution.

In some embodiments, said generating the first navigation solution comprises: determining a first navigation path of the movable object based on the observations, said first navigation path having a known starting point; calculating a traversed distance of the first navigation path; determining a plurality of candidate paths from the LBS feature map, each of the plurality of candidate paths starting from said known starting point and having a distance thereof such that the difference between the distance of each of the plurality of candidate paths and the traversed distance of the first navigation path is within a predefined distance-difference threshold; calculating a similarity between the first navigation path and each of the plurality of candidate paths; and selecting the one of the plurality of candidate paths that has the highest similarity for the first navigation solution.

In some embodiments, the site comprises a plurality of regions wherein each of the plurality of regions is associated with a local coordinate frame, and the site is associated with a global coordinate frame. The at least one processing structure is further configured for: generating a plurality of regional LBS feature maps, each of the plurality of regional LBS feature maps associated with a respective one of the plurality of regions and with the local coordinate frame thereof; transforming each of the plurality of regional LBS feature maps from the local coordinate frame associated therewith into the global coordinate frame; and combining the plurality of transformed regional LBS feature maps for forming the LBS feature map of the site.

According to one aspect of this disclosure, there is provided a method for tracking a movable object in a site. The method comprises: collecting sensor data from the a plurality of sensors; obtaining one or more observations based on the collected sensor data, said one or more observations spatially distributed over the site; retrieving a portion of the LBS features from a LBS feature map of the site, the LBS feature map stored in the memory and comprising a plurality of LBS features each associated with a location in the site; and generating a first navigation solution for tracking the movable object at least based on the one or more observations and the retrieved LBS features, said first navigation solution comprising a determined navigation path of the movable object and parameters related to the motion of the movable object. The plurality of LBS features in the LBS feature map is spatially indexed.

According to one aspect of this disclosure, there is provided one or more non-transitory computer-readable storage media comprising computer-executable instructions. The instructions, when executed, cause a processor to perform actions comprising: collecting sensor data from the a plurality of sensors; obtaining one or more observations based on the collected sensor data, said one or more observations spatially distributed over the site; retrieving a portion of the LBS features from a LBS feature map of the site, the LBS feature map stored in the memory and comprising a plurality of LBS features each associated with a location in the site; and generating a first navigation solution for tracking the movable object at least based on the one or more observations and the retrieved LBS features, said first navigation solution comprising a determined navigation path of the movable object and parameters related to the motion of the movable object. The plurality of LBS features in the LBS feature map are spatially indexed.

### BRIEF DESCRIPTION OF THE DRAWINGS

FIG. 1 is a schematic diagram showing a prior-art sensor data processing;

FIG. 2 is a schematic diagram of a navigation system, according to some embodiments of this disclosure;

FIG. 3 is a schematic diagram of a movable object in the navigation system shown in FIG. 2;

FIG. 4A is a schematic diagram showing a hardware structure of a computing device of the navigation system shown in FIG. 2;

FIG. 4B is a schematic diagram showing a simplified functional structure of the navigation system shown in FIG. 2;

FIG. 4C is a flowchart showing a process for object navigation;

FIG. 5 is a schematic diagram showing the structure of a location-based services (LBS) feature map and retrieving LBS features therefrom, according to some alternative embodiments of this disclosure;

FIG. 6 is a floor plan of a site of the navigation system shown in FIG. 2, showing a movable object traversing the site along a trajectory;

FIG. 7 is a schematic diagram of LBS feature map compression;

FIG. 8 shows a portion of a graph map represented by a Voronoi graph comprising nodes and links;

FIG. 9 is a flowchart showing a process of LBS feature map compression;

FIG. 10 is a flowchart showing a process for generating and/or updating a LBS feature map, according to some embodiments of this disclosure;

FIG. 11A shows the detail of a step of the process shown in FIG. 10, which extracts and adjusts the spatial structure;

FIG. 11B shows the detail of a step of the process shown in FIG. 10, which uses the distribution of observation statistics to adjust the spatial construction;

FIG. 12 shows a filtered skeleton of the LBS feature map after spatial interpolation, with consideration of the spatial structure of environment and distribution of sensor observations;

FIG. 13 shows the sensor data processing using the LBS feature map for IMU and other sensor bias-calibration and processing, according to some embodiments of this disclosure;

FIG. 14 is a block diagram showing the function structure of an enhanced SLAM process, according to some embodiments of this disclosure;

FIG. 15 is a flowchart showing a prior-art SLAM process using IMU and vision sensor;

FIG. 16 is a flowchart showing an enhanced SLAM process that uses and updates relative constraints in navigation, according to some embodiments of this disclosure;

FIG. 17 shows spatial sampling based on magnetometer anomalies in an indoor environment;

FIG. 18A shows a partially-determined navigation path, according to some embodiments of this disclosure;

FIG. 18B shows a plurality of candidate paths to be matched with the partially-determined navigation path shown in FIG. 18A;

FIG. 19A shows a calculated trajectory of a movable object in a site using IMU and a LBS feature map, according to some embodiments of this disclosure;

FIG. 19B shows a calculated trajectory of the movable object without using any

LBS feature map;

FIG. 20 shows a pedestrian dead reckoning (PDR) gyro-bias estimation result;

FIG. 21 shows alignment of a local or regional LBS feature map with a global LBS feature map or a reference LBS feature map;

FIG. 22A shows a floor plan of a testing site;

FIG. 22B is a picture showing the a testing site having glass walls;

FIGS. 23A and 23B show the test results of a standard SLAM positioning method without using a false loop-closure rejection process;

FIGS. 24A and 24B show the test results of the standard SLAM positioning method with the use of a false loop-closure rejection process for removing incorrectly-retained loop-closures, according to some embodiments of this disclosure; and

FIGS. 25A and 25B show test results of the enhanced navigation solution of FIG. 16 using a LBS feature map.

### DETAILED DESCRIPTION

System Overview

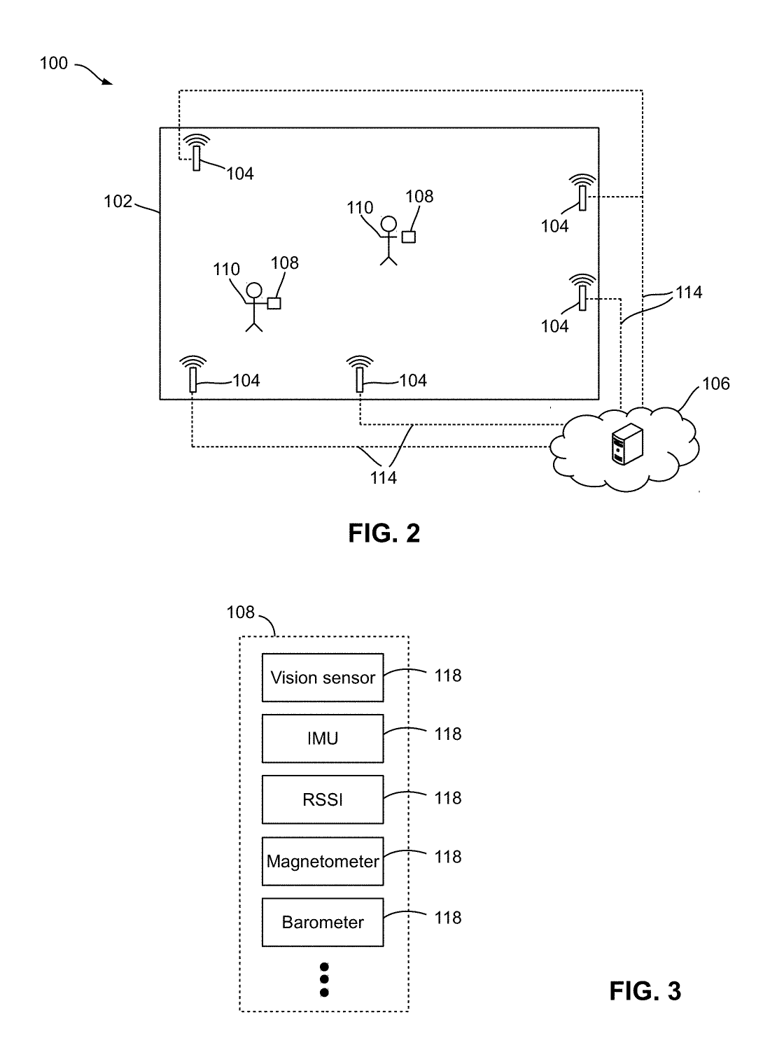

Turning now to FIG. 2, a navigation system is shown and is generally identified using reference numeral 100. Herein, the terms “tracking”, “positioning”, “navigation”, “navigating”, “localizing”, and “localization” may be used interchangeably with a similar meaning of determining at least the position of a movable object 108 in a site 102. Depending on the context, these terms may also refer determining other navigation parameters of the movable object 108 such as its pose, speed, heading, and/or the like.

The navigation system 100 tracks one or more movable objects 108 in a site 102 such as a building complex. The movable object 108 may be autonomously movable in the site 102 (for example, a robot, a vehicle, an autonomous shopping cart, a wheelchair, a drone, or the like) or may be attached to a user and movable therewith (for example, a specialized tag device, a smartphone, a smart watch, a tablet, a laptop computer, a personal data assistant (PDA), or the like).

One or more anchor sensors 104 are deployed in the site 102 and are functionally coupled to one or more computing devices 106. The anchor sensors 104 may be any sensors suitable for facilitating survey sensors (described later) of the movable object 108 to obtain observations that may be used for positioning, tracking, or navigating the movable object 108 in the site 102. For example, the anchor sensors 104 in some embodiments may be wireless access points or stations. Depending on the implementation, the wireless access points or stations may be WI-FI® stations, BLUETOOTH® stations, ZIGBEE® stations (ZIGBEE is a registered trademark of ZigBee Alliance Corp., San Ramon, Calif., USA), cellular base stations, and/or the like. As those skilled in the art will appreciate, the anchor sensors 104 may be functionally coupled to the one or more computing devices 106 via suitable wired and/or wireless communication structures 114 such as Ethernet, serial cable, parallel cable, USB cable, HDMI® cable (HDMI is a registered trademark of HDMI Licensing LLC, San, Jose, Calif., USA), WI-FI®, BLUETOOTH®, ZIGBEE®, 3G or 4G or 5G wireless telecommunications, and/or the like.

As shown in FIG. 3, the movable object 108 comprises one or more survey sensors 118 for example, vision sensors such as cameras for object positioning using computer vision technologies, inertial measurement units (IMUs), received signal strength indicators (RSSIs) that measure the strength of received signals (such as BLUETOOTH low energy (BLE) signals, cellular signals, WI-FI signals, and/or the like), magnetometers, barometers, and/or the like. Some of the survey sensors 118 may collaborate with one or more anchor sensors 104 such as in wireless communication with wireless access points or stations, for object positioning. Such wireless communication may be in accordance with any suitable wireless communication standard such as WI-FI®, BLUETOOTH®, ZigBee®, 3G or 4G or 5G wireless telecommunications or the like, and/or may be in any suitable form such as a generic wireless communication signal, a beacon signal, or a broadcast signal. Moreover, the wireless communication signal may be in either a licensed band or an unlicensed band, and may be either a digital-modulated signal or an analog-modulated signal. In some embodiments, the wireless communication signal may be an unmodulated carrier signal. In some embodiments, the wireless communication signal is a signal emanating from a wireless transmitter (being one of the sensors 104 or 118) with an approximately constant time-averaged transmitting power known to a wireless receiver (being the other of the sensors 104 or 118) that measures the RSS thereof

Those skilled in the art will appreciate that the survey sensors 118 may be selected and combined as desired or necessary, based on the system design parameters such as system requirements, constraints, targets, and the like. For example, in some embodiments, the navigation system 100 may not comprise any barometers. In some other embodiments, the navigation system 100 may not comprise any magnetometers.

Those skilled in the art will appreciate that, although Global Navigation Satellite System (GNSS) receivers such as GPS receivers, GLONASS receivers, Galileo positioning system receivers, Beidou Navigation Satellite System receivers, generally work well under relatively strong signal conditions in most outdoor environments, they usually have high power consumption and high network timing requirements when compared to many infrastructure devices. Therefore, while in some embodiments, the navigation system 100 may comprise GNSS receivers as survey sensors 118, at least in some other embodiments that the navigation system 100 is used for IoT object positioning, the navigation system 100 may not comprise any GNSS receiver.

In embodiments where RSS measurements are used, the RSS measurements may be obtained by the anchor sensor 104 having RSSI functionalities (such as wireless access points) or by the movable object 108 having RSSI functionalities (such as object having a wireless transceiver). For example, in some embodiments, a movable object 108 may transmit a wireless signal to one or more anchor sensors 104. Each anchor sensor 104 receiving the transmitted wireless signal, measures the RSS thereof and sends the RSS measurements to the computing device 106 for processing. In some other embodiments, a movable object 108 may receive wireless signals from one or more anchor sensors 104. The movable object 108 receiving the wireless signals measures the RSS thereof, and sends the RSS observables to the computing device 106 for processing. In yet some other embodiments, some movable objects 108 may transmit wireless signals to anchor sensors 104, and some anchor sensors 104 may transmit wireless signals to one or more movable objects 108. In these embodiments, the receiving devices, being the anchor sensors 104 and movable objects 108 receiving the wireless signals, measure the RSS thereof and send the RSS observables to the computing device 106 for processing.

In some embodiments, the movable objects 108 also send data collected by the survey sensors 118 to the computing device 106.

As the system 100 may use data collected by sensors 104 and 118, the following description does not differentiate the data received from the anchor sensors 104 and the data received from the survey sensors 118, and collectively denotes the data collected from sensors 104 and 118 as reference sensor data or simply sensor date.

The one or more computing devices 106 may be one or more stand-alone computing devices, servers, or a distributed computer network such as a computer cloud. In some embodiments, one or more computing devices 106 may be portable computing devices such as laptops, tablets, smartphones, and/or the like, integrated with the movable object 108 and movable therewith.

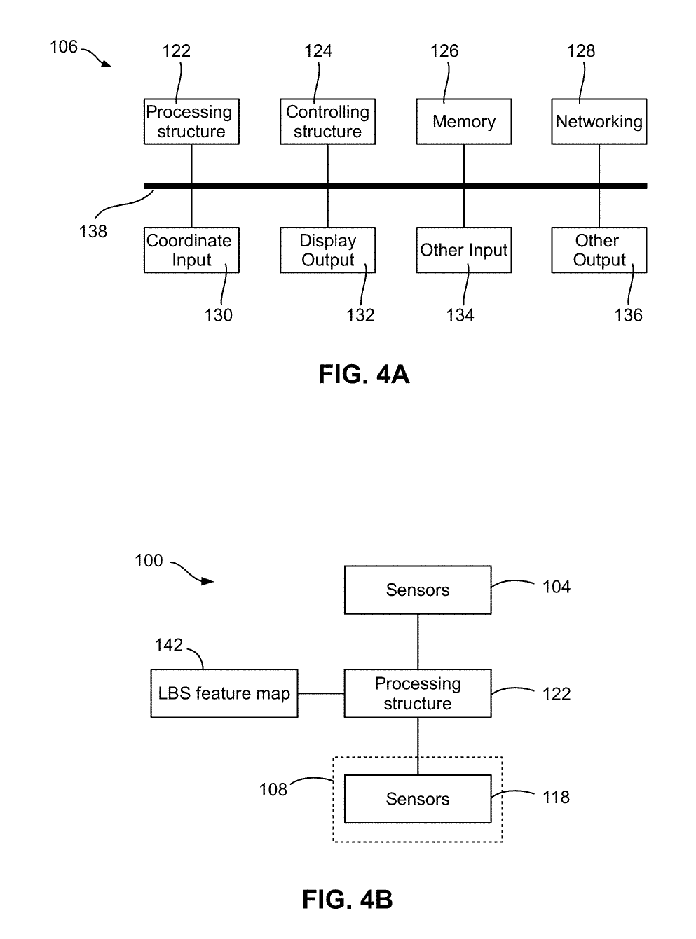

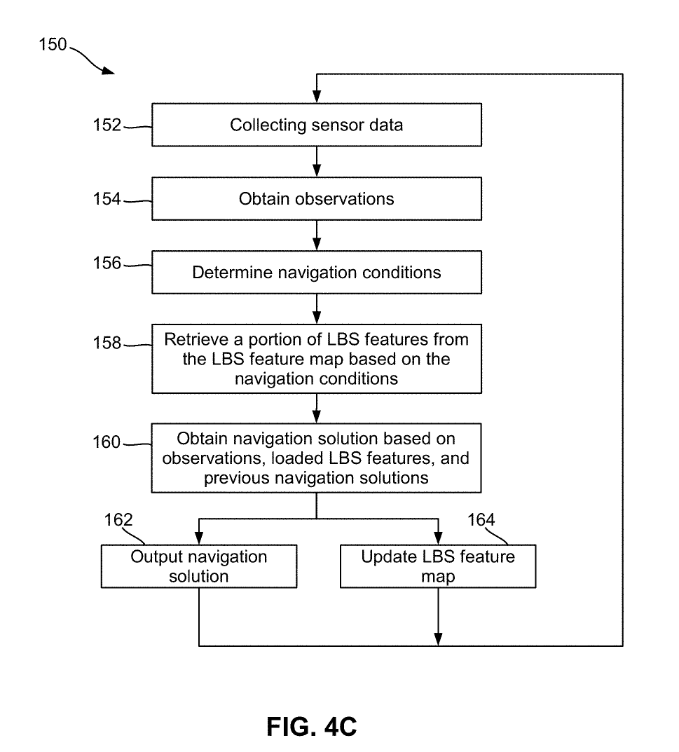

FIG. 4A shows a hardware structure of the computing device 106. As shown, the computing device 106 comprises one or more processing structures 122, a controlling structure 124, a memory 126 (such as one or more storage devices), a networking interface 128, a coordinate input 130, a display output 132, and other input modules and output modules 134 and 136, all functionally interconnected by a system bus 138.

The processing structure 122 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The controlling structure 124 comprises a plurality of controllers such as graphic controllers, input/output chipsets, and the like, for coordinating operations of various hardware components and modules of the computing device 106.

The memory 126 comprises a plurality of memory units accessible by the processing structure 122 and the controlling structure 124 for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided to a plurality of portions for different use purposes. For example, a portion of the memory 126 (denoted herein as storage memory) may be used for long-term data storing, for example storing files or databases. Another portion of the memory 126 may be used as the system memory for storing data during processing (denoted herein as working memory).

The networking interface 128 comprises one or more networking modules for connecting to other computing devices or networks through the network 106 by using suitable wired or wireless communication technologies such as Ethernet, WI-FI®, BLUETOOTH®, ZIGBEE®, 3G or 4G or 5G wireless mobile telecommunications technologies, and/or the like. In some embodiments, parallel ports, serial ports, USB connections, optical connections, or the like may also be used for connecting other computing devices or networks although they are usually considered as input/output interfaces for connecting input/output devices.

The display output 132 comprises one or more display modules for displaying images, such as monitors, LCD displays, LED displays, projectors, and the like. The display output 132 may be a physically integrated part of the computing device 106 (for example, the display of a laptop computer or tablet), or may be a display device physically separate from but functionally coupled to other components of the computing device 106 (for example, the monitor of a desktop computer).

The coordinate input 130 comprises one or more input modules for one or more users to input coordinate data from, for example, a touch-sensitive screen, a touch-sensitive whiteboard, a trackball, a computer mouse, a touch-pad, or other human interface devices (HID), and the like. The coordinate input 130 may be a physically integrated part of the computing device 106 (for example, the touch-pad of a laptop computer or the touch-sensitive screen of a tablet), or may be a display device physically separate from but functionally coupled to other components of the computing device 106 (for example, a computer mouse). The coordinate input 130, in some implementations, may be integrated with the display output 132 to form a touch-sensitive screen or a touch-sensitive whiteboard.

The computing device 106 may also comprise other inputs 134 such as keyboards, microphones, scanners, cameras, and the like. The computing device 106 may further comprise other outputs 136 such as speakers, printers and the like.

The system bus 138 interconnects various components 122 to 136 enabling them to transmit and receive data and control signals to/from each other.

Depending on the types of localization sensors 104 and 118 used, the navigation system 100 may be designed for robust indoor/outdoor seamless object positioning, and the processing structure 122 may use various signal-of-opportunities such as BLE signals, cellular signals, WI-FI®, earth magnetic field, 3D building models, floor maps, point clouds, and/or the like, for object positioning.

FIG. 4B shows a simplified functional structure of the navigation system 100. As shown, the processing structure 122 is functionally coupled to the sensors 104 and 118 and a location-based services (LBS) feature map 142 stored in a database in the memory 126. As will be described in more detail later, the LBS feature map 142 comprises a plurality of LBS-related features which are generally parameters and/or models that may be used as references for tracking the movable objects 108 in the site 102.

The processing structure 122 executes computer-executable code stored in the memory 126 which implements an object positioning and tracking process for collecting sensor data from sensors 104 and 118, and uses the collected sensor data and the LBS feature map 142 for tracking the movable objects 108 in the site 102. The processing structure 122 also uses the collected sensor data to update the LBS feature map 142.

FIG. 4C is a flowchart showing a general process 150 executed by the processing structure 122 for object navigation.

At step 152, the processing structure 122 collects data from sensors 104 and 118. At step 154, the processing structure 122 analyzes the collected data to obtain navigation observations (or simply “observations”). The observations may be any suitable characteristics related to the movement of the movable object 108, and may be generally categorized as environmental observations such as points cloud, magnetic anomalies, barometer readings, and/or the like, along the movement path or trajectory of the movable object 108, and motion observations such as velocity, acceleration, pose, and/or the like. Those skilled in the art will appreciate that the observations are associated with the location of the movable object 108 at which the observations are obtained.

At step 156, the processing structure 122 determines one or more navigation conditions such as spatial conditions, motion conditions, magnetic anomaly conditions, and/or the like. Then, the processing structure 122 determines a portion of the LBS features in the LBS feature map that is relevant for object tracking under the navigation conditions and load the determined portion of the LBS features from the LBS feature map (step 158). At step 160, the processing structure 122 obtains an integrated navigation solution based on the observations and loaded LBS features. In some embodiments, the processing structure 122 may obtain the integrated navigation solution based on the observations, loaded LBS features, and previous navigation solutions.

The obtained integrated navigation solution comprises necessary information for object navigation such as the current position of the movable object 108, the path of the movable object 108, the speed, heading, pose of the movable object 108, and the like. The integrated navigation solution and/or a portion thereof may be output for object tracking (step 162), and/or used for updating the LBS feature map (step 164). Then, the process 150 loops back to step 152 to continue the tracking of the movable object 108.

At step 160, the processing structure 122 may use any suitable methods for obtaining the integrated navigation solution. For example, the processing structure 122 may obtain a pattern from images captured by a vision sensor 118 of the movable object 108, and compare the retrieved pattern with reference patterns in the LBS feature map 142 to determine the position of the movable object 108. In another example, the processing structure 122 may further compare a received barometer reading with reference barometer readings in the LBS feature map 142, and combine the barometer reading comparison result with the image pattern comparison result to more accurately calculate the position of the movable object 108.

The processing structure 122 may use any suitable method for calculating the location of a movable object 108 using data collected by the localization sensors 104 and 118. For example, the commonly used fingerprinting algorithms can be used to estimate the current location given some information such as signature/feature databases. Those skilled in the art will appreciate that the LBS feature map 142 may store historical sensor data, and the processing structure 122 may use the stored historical sensor data for determining the object locations.

LBS Feature Map

Herein, the LBS features refer to data-processing model parameters relate to the site 102 and devices and/or signals therein that may be used as references for tracking the movable objects 108 in the site 102.

The LBS features may comprise spatial-dependent LBS features such as the time-of-arrival (TOA) observations and received signal strength indicator (RSSI) vectors (also called fingerprints) for access points/gateways at known locations, magnetometer anomalies, landmark locations and their world coordinates in the image/point cloud, building models/structures, spatial constraints, and/or the like. The LBS feature map 142 may comprise the distribution of spatial-dependent LBS features and their statistical information over the site 102.

The LBS features may also comprise other LBS features such as device-dependent LBS features, time-dependent LBS features, and the like. Examples of device-dependent LBS features include sensor error models such as the gyro/accelerometer error models, sensor bias/scale factor parameters, and/or the like. Examples of time-dependent LBS features include GNSS satellites' positions, GNSS satellites' velocities, atmosphere/ionosphere correction model parameters, clock-error-compensating model parameters, and/or the like. In some embodiments, the device-dependent LBS features, time-dependent LBS features, and the like may also be spatially related. For example, in one embodiment, different locations of site 102 may have different gyro models adapting to the geographic characteristics of the respective locations.

In the examples described below, the LBS features are mainly spatial-dependent and device-dependent LBS features that may also be spatially related.

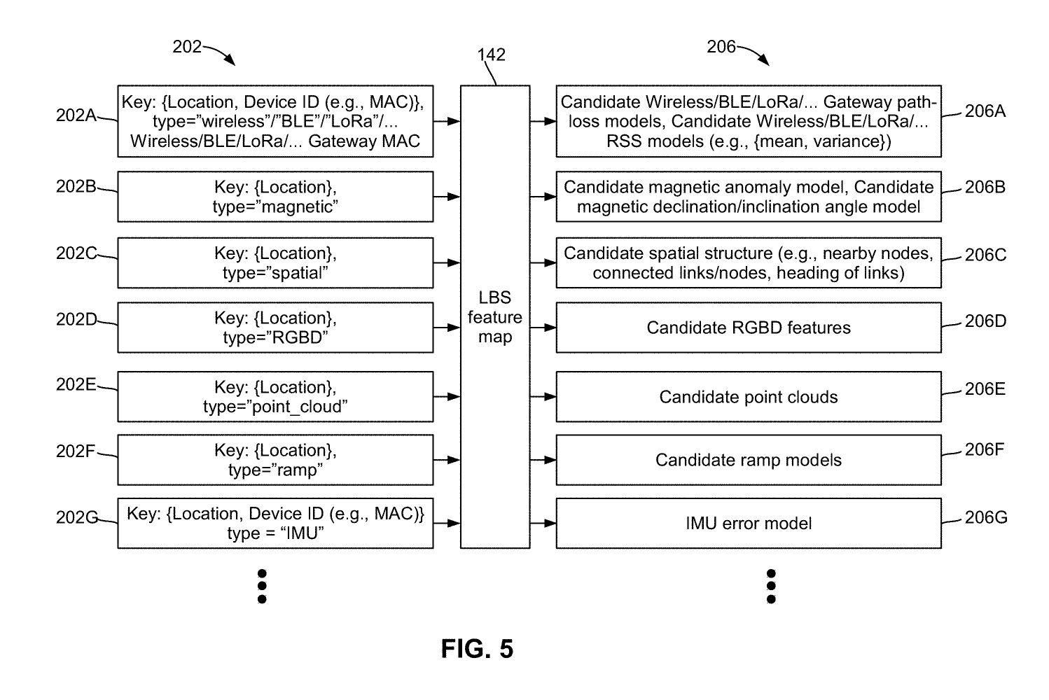

As shown in FIG. 5, LBS features may be stored in a LBS feature map 142 as (key, type, data) sets. In particular, the “data” field of a (key, type, data) set stores the value of a LBS feature, the “type” field thereof stores the type of the LBS feature, and the “key” field thereof stores the location of the LBS feature and other properties such as an identification (ID) thereof that may be used to identify the LBS feature. Therefore, the LBS features in the LBS feature map 142 are indexed by their associated locations (i.e., spatially indexed) and the LBS feature types. The LBS features may be further indexed by other suitable properties thereof

Those skilled in the art will appreciate that such (key, type, data) sets may be implemented in any suitable manner for example, as a two-dimensional array with the indices thereof being the key and type fields and the value of each array element being the data field.

For example, a LBS feature of a RSSI measurement of a LoRa-network signal may be stored in the feature map 142 as a (key, type, data) set with key comprising the location associated with the LBS feature and the device ID of the transmitter of the LoRa-network signal such as the Media Access Control (MAC) address thereof, type being “LoRa” for indicating that the LBS feature is related to a LoRa-network signal, and data being the RSS model parameters such as the mean and variance of the LoRa-network signal.

A LBS feature of a magnetic model parameters may be stored in the feature map 142 as a (key, type, data) set with key comprising the location associated with the LBS feature, type being “magnetic” for indicating that the LBS feature is related to a magnetic model, and data being the magnetic model parameters.

The LBS feature map 142 is associated with suitable methods for efficiently generating, re-evaluating, and updating the LBS feature “data” with encoding of related spatial structure of the site 102 and data variability information. The LBS feature map stores the LBS features and related information of location, device, spatial information, and/or the like, and may be easily searched by providing values of the key and the type (202) for retrieving LBS features (206) during object positioning.

For example, by using a location and a MAC address of a wireless gateway as the key and using “wireless” as the type (202A), the mean and variance of the wireless received signal parametric error model (or RSS model) and the path-loss model parameters of this gateway for this location (206A) can be retrieved from the LBS feature map 142.

By using a location of magnetic sensor as the key and “magnetic” as the type (202B), the magnetic anomaly model parameters such as the mean and variance of the norm, horizontal, and vertical magnetic anomaly and the mean and variance of the magnetic declination angles at this location (206B) can be retrieved from the LBS feature map 142.

By using a location as the key and “spatial” as the type (202C), the connectivity of nodes or links (206C) can be retrieved from the LBS feature map 142.

By using a location as the key and “RGBD” or “point cloud” as the type (202D or 202E), visual features (206D or 206E) may be retrieved from the LBS feature map 142, which may be used for loop closure detection.

By using a location as the key and “ramp” as the type (202F), the mean and variance of a ramp model at this location (206F) may be retrieved from the LBS feature map 142.

By using a location as the key and “IMU” as the type (202G), the IMU error model (206G) may be retrieved from the LBS feature map 142.

Generating and Updating LBS Feature Map

The LBS feature map 142 stores a plurality of sensor/data models that encode or describe the spatial constraints and/or other types of constraints. In some embodiments, the system 100 uses SLAM for providing a robust large-area LBS over time in a site 102 with various sensors for example, wireless modules, IMUs, and/or image sensors. In these embodiments, the system 100 generates location-based services (LBS) features based on the reference sensor data. The system 100 may partition the site 102 into a plurality of regions and construct a set of LBS features for each region. Then, the system gradually builds and updates a globally aligned LBS feature map in a region-by-region manner such that movable objects 108, including movable objects with limited functionalities, can benefit from using such LBS feature map for satisfactory positioning performance. Herein, the term “aligning” refers to transformation of LBS features and their associated coordinates in each region into a unified “global” feature map system such that the LBS features and their associated coordinates are consistent from region to region.

In some embodiments, the LBS feature map 142 may be generated and/or updated by using the sensor data collected while a movable object 108 traverses the site 102. In particular, the collected sensor data is analyzed to obtain observations as the LBS features. The obtained LBS features are associated with respective keys and types to form the LBS feature map.

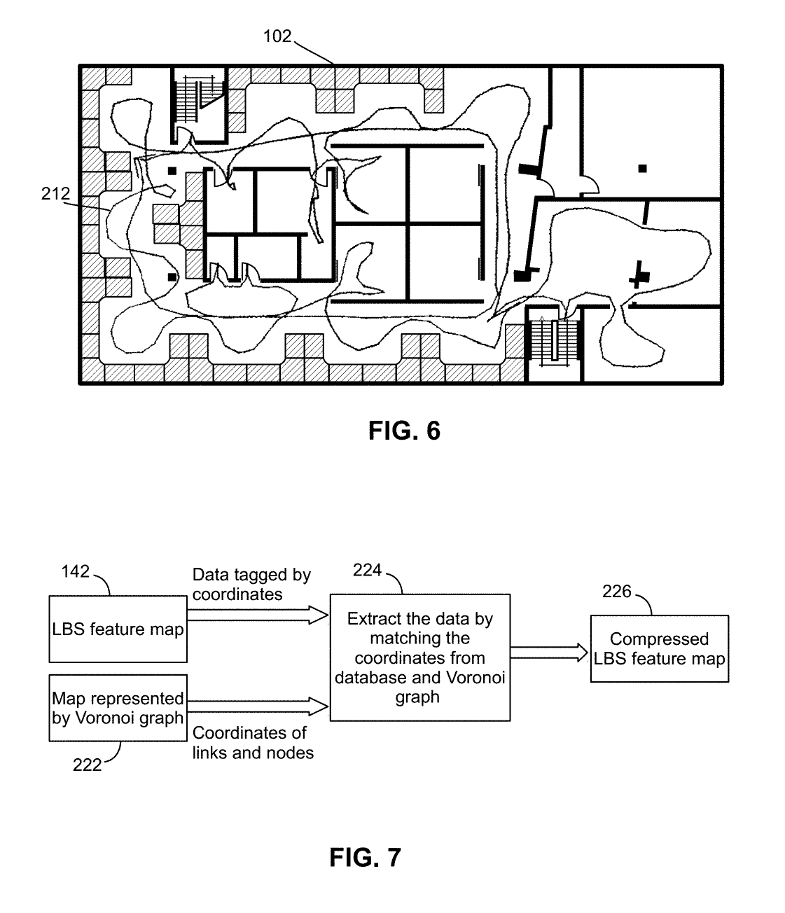

As shown in FIG. 6, a movable object 108 such as a survey vehicle (not shown) traverses the site 102 along a trajectory 212. Sensor data is collected from the sensors 104 and 118 during the object's movement along the trajectory 212. The object 108 may visit some areas of the site 102 more extensively and consequently more sensor data may be collected in these areas than in other areas therein. Moreover, the object 108 may visit some locations more than once thereby forming loop closures at these locations.

As those skilled in the art will appreciate, the generated (raw) LBS feature map 142 may comprise a large number of LBS features. Such a raw LBS feature map 142 may be compressed without significantly affecting the accuracy of object positioning.

In some embodiments, the processing structure 122 executes a LBS feature map compression method to transform the raw LBS feature map into a 2D skeleton (also called “topological skeleton”) based on graph theory algorithms such as Voronoi diagram or graph, extended Voronoi diagrams, and the like, thereby achieving reduced correspondence between accurate object trajectory and multi-source sensor readings. As those skilled in the art understand, a graph is a structure of a set of related objects in which the objects are denoted as nodes or vertices and the relationship between two nodes is denoted as a link or edge.

FIG. 7 is a schematic diagram of LBS feature map compression. As shown, the processing structure 122 uses the raw LBS feature map 142 and a graph map 222 of the site 102 to build a compressed LBS feature map 226. The raw LBS feature map 142 is built as described above and comprises LBS features indexed by coordinates.

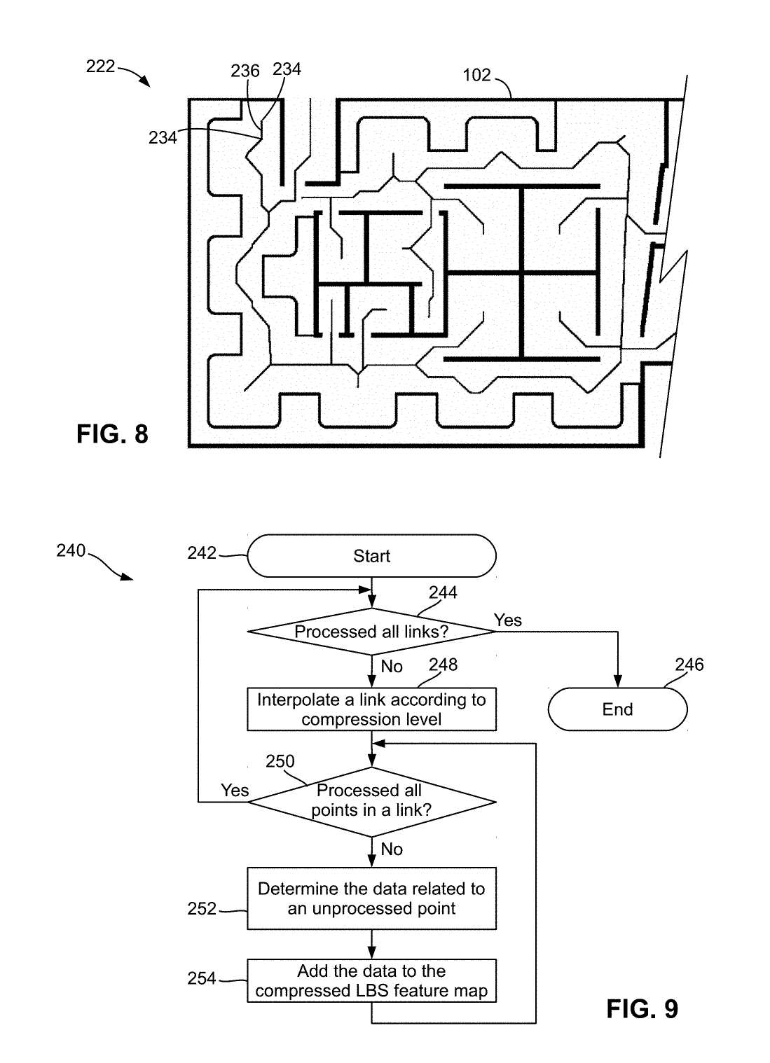

As shown in FIG. 8, the graph map 222 is represented by a Voronoi graph (also identified using reference numeral 222) and comprises coordinates of nodes 234 and links 236 connecting adjacent nodes 234. By using the LBS feature map 142 and the graph map 222, a compression engine which may be implemented as one or more programs executed by the processing structure 122, extracts data from the LBS feature map 142 by matching the coordinates of the extracted data with the Voronoi graph of the graph map 222, and builds the compressed LBS feature map 226.

FIG. 9 is a flowchart showing a process 240 of LBS feature map compression, executed by the processing structure 122. After the process starts (step 242), the processing structure 122 first checks if all links 236 stored in a Voronoi graph 222 have been processed (step 244). If all links 236 in the Voronoi graph 222 have been processed (the “Yes” branch thereof), the process ends (step 246).

If there exists at least one link 236 in the Voronoi graph 222 not yet being processed (the “No” branch thereof), the processing structure 122 selects an unprocessed link 236, and interpolates the selected link 236 to obtain the coordinates of points thereon between the two nodes 234 thereof according to a predefined compression level (step 248). In these embodiments, one or more compression levels may be defined with each compression level corresponding to a respective minimum distance between two points (including the two nodes 234) along a link 236 after interpolation. In other words, at each compression level, the distance between each pair of adjacent points (including the interpolated points and the two nodes 234) along a link 236 must be longer than or equal to the minimum distance predefined for this compression level. In these embodiments, a higher compression level has a longer minimum distance. Therefore, a LBS feature map compression with a higher compression level requires less interpolation points and gives rise to a smaller compressed LBS feature map 226 but with a coarser resolution. On the other hand, a LBS feature map compression with a lower compression level requires more interpolation points thereby giving rise to a larger compressed LBS feature map 226 but with a finer resolution.

After link interpolation at step 248, the processing structure 122 checks if all points (including the two nodes 234 and the interpolated points) in the link 236 are processed (step 250). If all points in the link 236 are processed (the “Yes” branch thereof), the process 240 loops back to step 244 to process another link 236. If one or more points in the link 236 have not been processed (the “No” branch of step 250), the processing structure 122 determines the LBS features related to each unprocessed point in the raw LBS feature map 142 (step 252). In these embodiments, the LBS features related to an unprocessed point are determined based on the position (for example, the coordinates) associated therewith. For example, if the position associated with a LBS feature is within a predefined distance range about the unprocessed point (for example, the distance therebetween is smaller than a predefined distance threshold), then the LBS feature is related to the unprocessed point.

At step 254, the processing structure 122 adds the determined LBS features related to the unprocessed point into the compressed LBS feature map 226, and marks the unprocessed point as processed. The process then loops back to step 250.

Comparing to the uncompressed LBS feature map 142, the compressed LBS feature map 226 comprise much less LBS features which are generally distributed along the Voronoi graph 222 of the site 102. Therefore, the compressed LBS feature map 226 may be much smaller in size thereby saving a significant amount of storage space, and may be faster for indexing/searching thereby significantly improving the speed of objection localization and tracking which may be measured by, for example, the delay between the time of a movement of a movable object 108 in the site 102 and the time that the system 100 detects such movement and updates the position of the movable object 108.

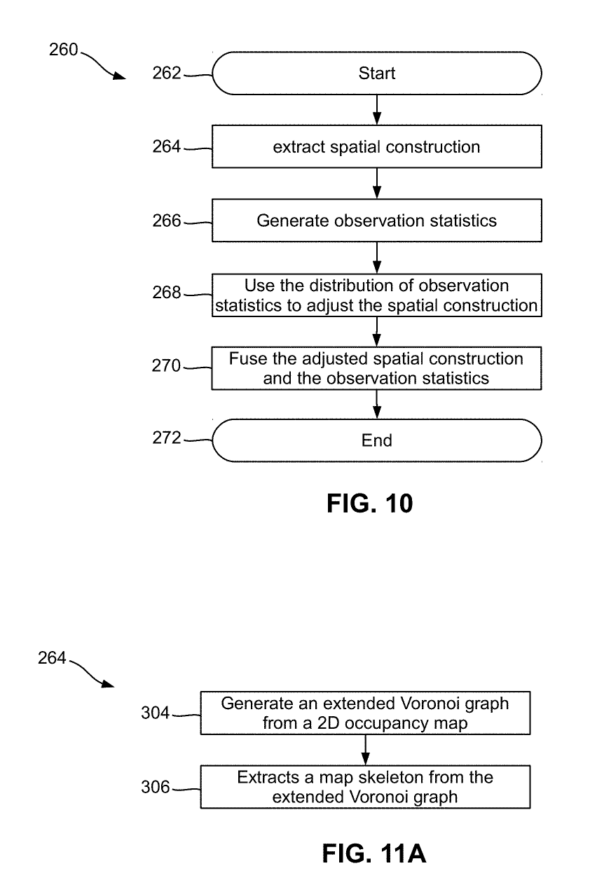

FIG. 10 is a flowchart showing a process 260 executed by the processing structure 122 for generating and/or updating a LBS feature map 142 in some embodiments. After the process 260 starts (step 262), the processing structure 122 obtains a spatial structure such as point clouds or an occupancy map thereof from the observations of the site 102, then simplifies the spatial structure into a skeleton (step 264), and calculates the statistic distribution of the observations such as observation heat-maps, statistics of raw observations, and/or the like (step 266). Then, the processing structure 122 uses the spatial statistic distribution of the observations for adjusting the skeleton, for example merging, adding, and/or deleting nodes and/or links in the skeleton (step 268). At step 270, the processing structure 122 fuses the adjusted skeleton and the observation distribution for obtaining updated LBS features, associates the updated LBS features with their respective locations, and stores the updated LBS features. The LBS feature map 142 is then generated or updated and the process ends (step 272).

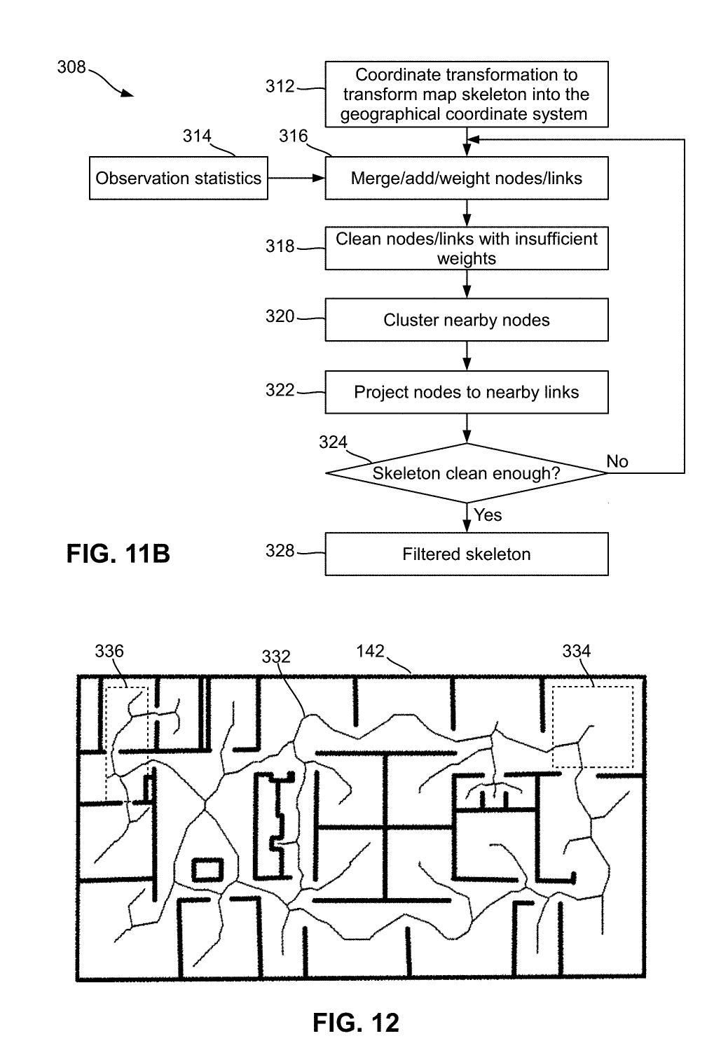

FIG. 11A shows the detail of step 264 of extracting and adjusting the spatial structure in some embodiments. As shown, the processing structure 122 generates a Voronoi graph as the skeleton by transforming the spatial structure, for example, a 2D occupancy map into a Voronoi graph (step 304). Such a transformation is also called “thinning” from the 2D occupancy map, and methods of such transformation are known in the art and therefore are omitted herein.

At step 306, the processing structure 122 extracts a map skeleton from the Voronoi graph (see FIG. 8 for an example). The map skeleton is represented by nodes and links, and is a simplified but topologically equivalent version of the 2D occupancy map. The data of a node comprises its location and its connectivity with the links. The data of a link comprises its start and end nodes, its length, and its direction. The process 300 then goes to step 266 shown in FIG. 10.

FIG. 11B shows the detail of step 268 in FIG. 10. As shown, the processing structure 122 transforms the coordinates of the nodes from the image frame to the global geographical frame such as WGS 84 which is a standard coordinate system for the Earth (step 312).

The processing structure 122 then repeatedly filters the skeleton by merging, adding, and weighting the nodes and links of the skeleton (step 316; observation statistics 314 may be used at this step), cleaning nodes and links of the skeleton that have insufficient weights such as those with weights less than a predefined weight threshold (step 318), clustering nearby nodes (for example, the nodes with distances therebetween smaller than a predefined distance threshold; step 320), and projecting nodes to nearby links (for example, projecting nodes to links at distances within a predefined range threshold; step 322). At step 324, the processing structure 122 checks if the skeleton is sufficiently clean. If not, the process 300 loops back to step 316 to repeat the filtering of the skeleton. If the skeleton is sufficiently clean, the filtered skeleton is generated and is used for updating the map skeleton.

Two types of constraints are used in filtering the skeleton (steps 316 to 322). The first type of constraint is the geographical relationships between the nodes and links which includes merging adjacent links (for example, two or more links located within a predefined link-distance threshold), cleaning one or more unnecessary links such as links with a length thereof shorter than a predefined length threshold, merging nearby nodes (for example, two or more nodes located within a predefined node-distance threshold), projecting one or more nodes to nearby links (for example, to links at a distance thereto shorter than a predefined node-distance threshold), and the like.

The second type of constraint is based on the observation statistics 314 such as observation heat-map, statistics of raw observations, and/or the like. Specifically, for each existing node in the skeleton, the processing structure 122 may select sensor observations with location keys geographically close to the existing node, and then calculate the statistics (for example, count, mean, variance, and/or the like) of the selected observations. Then, the processing structure 122 may adjust the nodes and links in the area around the existing node based on the statistics. If the observation distribution is relatively flat or sparse (such as having few samples or the number of samples of the observations in the area being less than a first predefined number-threshold), then the processing structure 122 may merge the nodes in this area and remove the links therebetween because less detailed meshing or spatial structure is required in this area. If the observation distribution has significant features (such as the number of samples of the observations in the area being greater than a second predefined number-threshold), one or more new nodes and links may be added in this area and linked to the existing node.

Thus, the processing structure 122 in some embodiments encodes the spatial structure to LBS features with the consideration of the observation distribution or variability.

FIG. 12 shows the filtered skeleton 332 of the LBS feature map 142 after above-described spatial interpolation with consideration of the spatial structure of environment and distribution of sensor observations. As can be seen, the nodes of the skeleton 332 (shown as vertices of the lines therein) has fewer nodes in area 334 (i.e., the lines therein appearing to be straight-line segments) than other areas as the area 334 has fewer observation samples therein thereby implying that the likelihood that a movable object 108 enters area 334 is lower than entering other areas. Similarly, the nodes of the skeleton 332 has more nodes in area 336 (i.e., the lines therein appearing to be curves) than other areas as the area 336 has more observation samples therein thereby implying that the likelihood that a movable object 108 enters area 334 is higher than entering other areas.

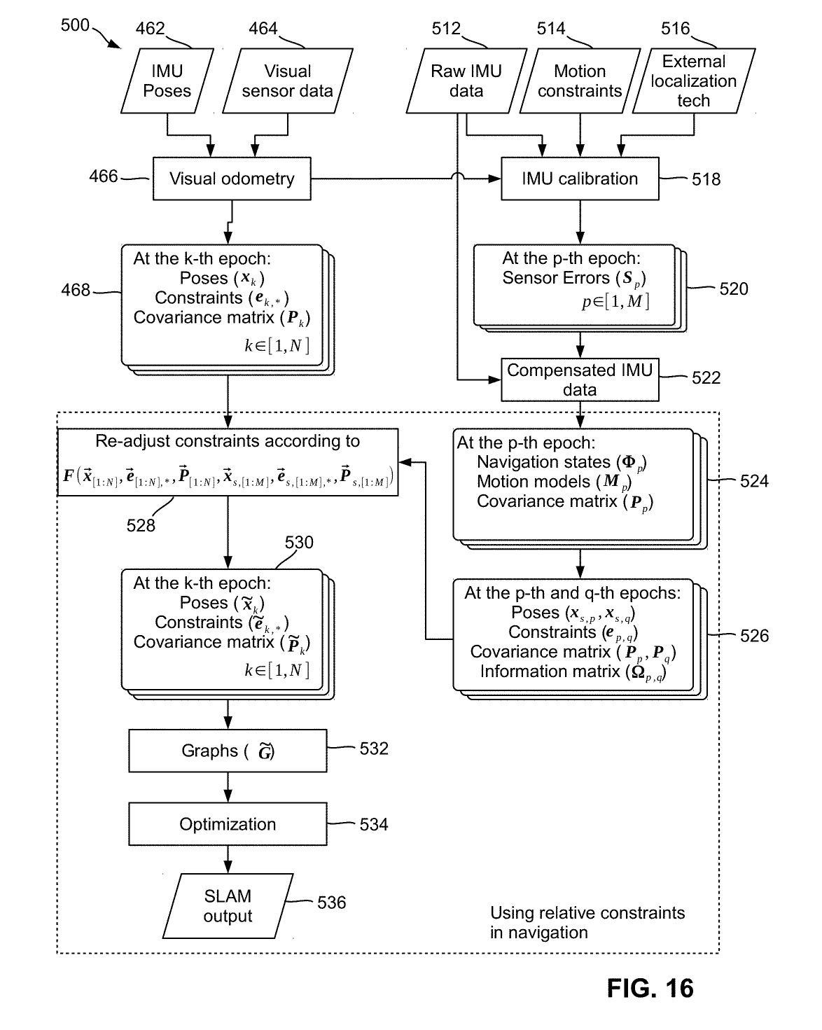

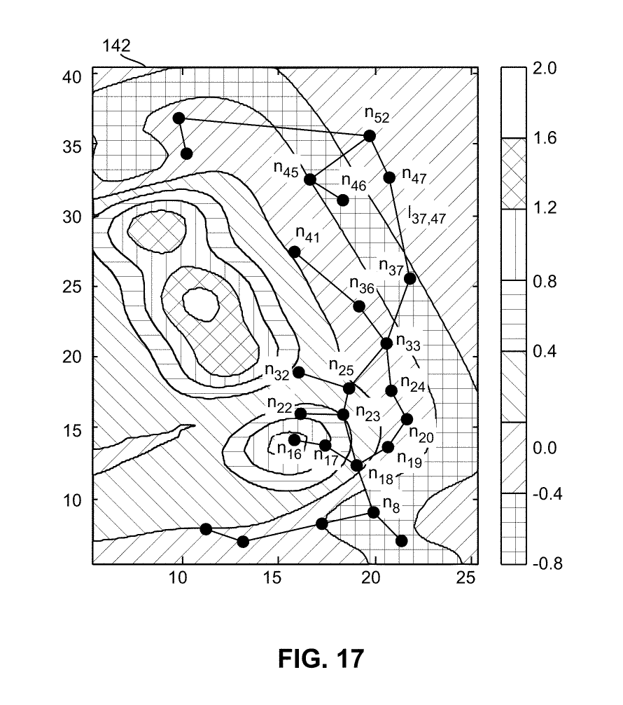

While being used later for illustration of spatial path matching, FIG. 17 shows a region of the LBS feature map 142 with a portion of a skeleton 542 formed by nodes and links. The shaded areas in FIG. 17 represent a background heat-map showing the distribution of the magnetometer norm (i.e., anomalies mean) over the region. The dots and links respectively represent the nodes and links of the skeleton 542 generated with consideration of the spatial structure and the magnetometer observation distribution. The sensor data statistics on the nodes' positions can be extracted and stored.

In some embodiments, the processing structure 122 repeatedly or periodically executes a process of encoding the spatial structure to LBS features with the consideration of the spatial structure and the observation distributions, and combining and updating LBS features in the LBS feature map. Therefore, the corresponding skeleton and the LBS feature map may evolve over time thereby adapting to the navigation environment and the changes therein.

In one embodiment, the system 100 accumulates and stores historical observations, and uses the accumulated historical observations for updating the LBS feature map as described above. In another embodiment, the system 100 does not accumulate historical observations. Rather, the system 100 uses a suitable pooled statistics method to process the current LBS feature map with current observations to update the LBS feature map.

Using LBS Feature Map

Special constraints may be used to improve the positioning performance. For example, in navigation solutions where special spatial constraints such as map matching are used, the process thereof includes: (a) using sensor data and LBS features to perform the navigation solution; and (b) applying the map constraints in the navigation solution domain. While it may be simple to implement and easy to use, such a process may lose the degree of freedom in higher dimensions such as individual sensor's sensing dimension or each data model's dimensions. Moreover, storing/processing such map constraints for real-time LBS in some scenarios may take a significant amount of memory and may be time-consuming.

Particle filter methods may be used in the map-matching method which propagate all the particles for each epoch, evaluate which particles are still within the spatial-constraint boundaries after propagation, and update the navigation solution with the survived particles. One limitation is that the so-called motion model constraints or maps are fixed and cannot be updated as more and more observations are processed. Moreover, regional shapes such as triangles or polygons are often stored as features representing the map directly as a special kind of observation.

In some embodiments, such triangles or polygons are not directly stored or treated as observations. Rather, a weighted spatial meshing/interpolation method is used to represent or encode the spatial constraints as keys in the LBS feature map. In this way, the spatial constraints are also related to the observation distributions. For example, in regions that the observation distribution is relatively flat or sparse (i.e., having few samples), less detailed meshing or spatial structure is required. These spatial structures are used to compress and encode the LBS features in the LBS features map.

The system 100 in some embodiments may provide a location service such as positioning a target object 108 in the site 102 by using an object-positioning process with the steps of (A-i) collecting sensor data related to the target object 108; (A-ii) using collected data to find corresponding spatial-structure-encoded data/sensor model(s) in the LBS feature map 142; and (A-iii) directly positioning the target object 108 using the spatial-structure-encoded data/sensor model(s) found in the LBS feature map 142.

Step (A-ii) of above process generally determines a set of constraints based on collected data and applies the constraints to the LBS feature map to exclude LBS features unrelated or at least unlikely related to the object navigation at the current time or epoch. As a result, the system at step (A-iii) only needs to load a relevant portion of the LBS feature map 142 and searches therein for object navigation thereby saving memory required for storing the loaded LBS features and reducing the time required for obtaining a navigation solution. Such a process makes the LBS more flexible in complex environments.

Traditional sensor data processing methods commonly use Gaussian-distributed error models with pre-defined or adaptively-computed parameters such as measurement noises for typical application scenarios and/or objects modes (for example, static, moving slowly, moving fast, walking, running, climbing stairs, and the like). In practice, the traditional sensor data processing methods may be difficult to obtain an accurate location-aware sensor model for updating navigation solutions.

In some embodiments, the LBS feature map 142 may be used for enhancing on-line sensor calibration during computing navigation solution. In these embodiments, the processing structure 122 may calculate and store the uncertainty of the sensor models for each region within the LBS feature map, which provides an extra apriori information of parameters for the sensor processing updates.

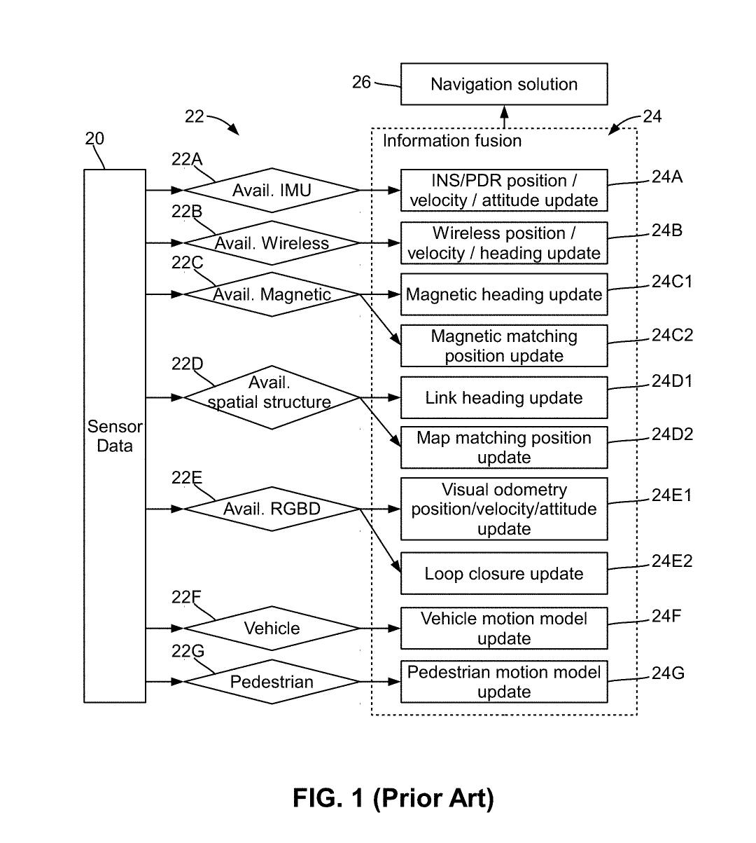

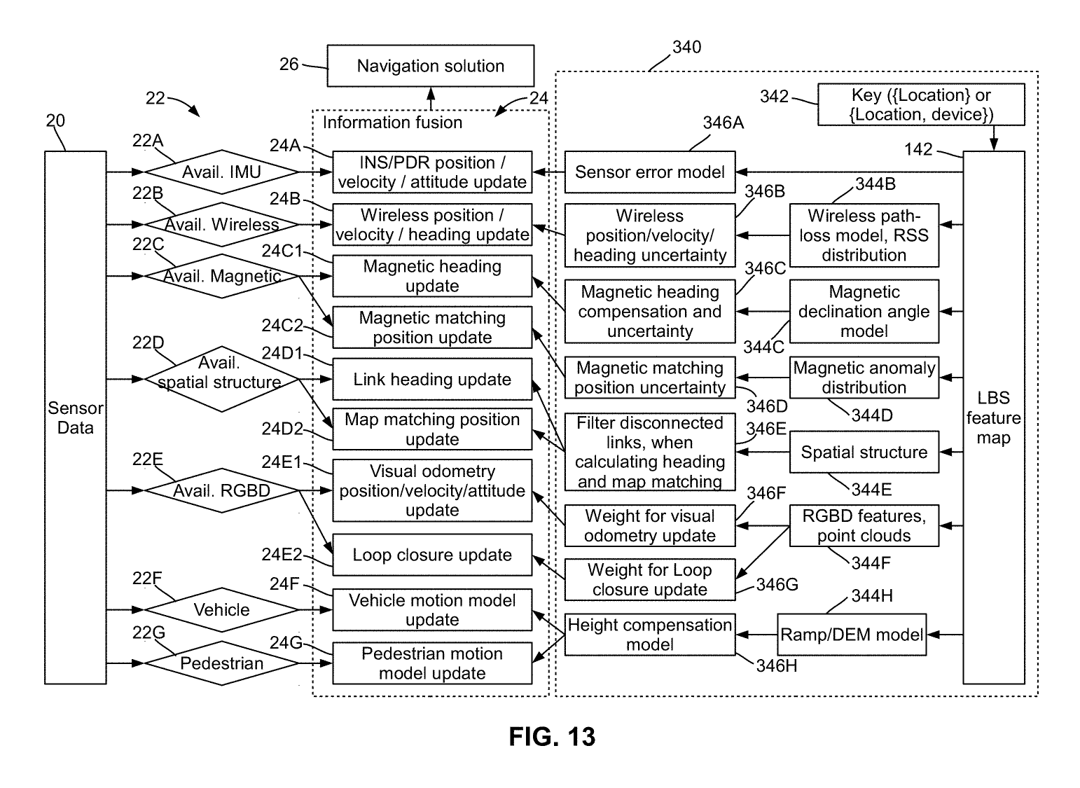

FIG. 13 shows the sensor data processing in these embodiments using the LBS feature map 142 for IMU and other sensor bias-calibration and processing. Compared to the sensor data processing shown in FIG. 1, the sensor data processing shown in FIG. 13 further comprises a LBS-feature-map-based processing section 340.

In the LBS-feature-map-based processing section 340, the processing structure 122 may use a location or (location, device) as the key 342 to obtain statistics of observations from the LBS feature map 142. For example, the processing structure 122 may extract a sensor error model 346A from the LBS feature map 142 using the above-described key, and process available IMU data 22A using an INS and/or PDR method and the extracted sensor error model 346A for updating the position/velocity/attitude 24A.

The processing structure 122 may extract a wireless path-loss model and RSS distribution 344B from the LBS feature map 142 using a suitable key and determine the wireless position/velocity/ heading uncertainty 346B. Then, the processing structure 122 may process RSSI observations 22B using fingerprinting or multilateration and the determined uncertainty 346B for position/velocity/attitude updates 24B.

The processing structure 122 may extract a magnetic declination angle model 344C from the LBS feature map 142 using suitable key and determine magnetic heading compensation and uncertainty 346C. Then, the processing structure 122 may process available magnetometer data 22C using the determined uncertainty 346C for providing magnetic heading updates 24C1.

Similarly, the processing structure 122 may extract a magnetic anomaly distribution 344D from the LBS feature map 142 using suitable key and determine magnetic matching position uncertainty 346D. Then, the processing structure 122 may process available magnetometer data 22C using the determined uncertainty 346D for providing magnetic matching position update 24C2.

The processing structure 122 may extract the spatial structure model 344E from the LBS feature map 142 using suitable key and, when calculating heading and map matching, filter the disconnected links thereof 346E. Then, the processing structure 122 may process available spatial structure data 22D such as skeleton data using the filtered spatial structure model 346E for providing link heading update 24D1 or map matching position update 24D2.

The processing structure 122 may extract RGBD features, point clouds, and the like (344F) from the LBS feature map 142 using suitable key and calculate weight for visual odometry update 346F. Then, the processing structure 122 may process available RGB-D images or point clouds 22E using the calculated weight for visual odometry update 346F for providing visual odometry position/velocity/attitude update 24E1.

Similarly, the processing structure 122 may extract RGBD features, point clouds, and the like (344F) from the LBS feature map 142 using suitable key and calculate weight for loop closure update 346G. Then, the processing structure 122 may process available RGB-D images or point clouds 22E using the calculated weight for loop closure update 346G for providing loop closure update 24E2 when a loop closure is detected.

If the movable object 108 is a vehicle 22F, the processing structure 122 may extract relevant models 344H such as a ramp/DEM model, determine a height compensation model 346H, and combine the determined height compensation model 346H with vehicle motion model constraints such as non-holonomic constraints for providing vehicle motion model update 24F.

Similarly, if the movable object 108 is a device movable with a pedestrian 22G, the processing structure 122 may combine the determined height compensation model 346H with pedestrian motion model constraints for providing pedestrian motion model update 24G.

In some embodiments, the processing structure 122 executes an enhanced SLAM process using efficiently added relative constraints from buffered navigation solutions for improving object positioning performance.

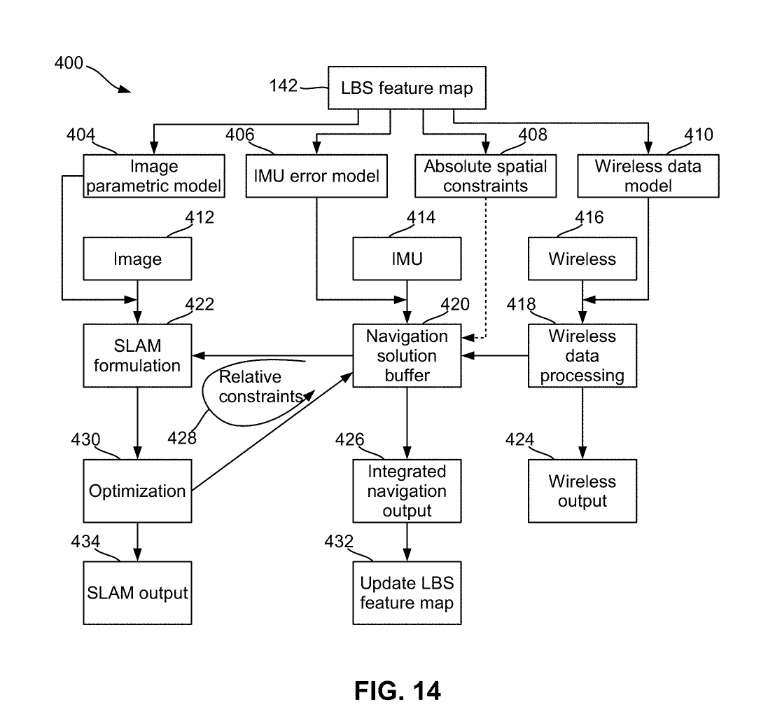

FIG. 14 is a block diagram showing the function structure 400 of the enhanced SLAM process. A shown, the LBS feature map 142 in these embodiments comprises an image parametric model 404, an IMU error model 406, absolute special constraints 408, and a wireless data model 410. The system 100 uses images 412 captured by a vision sensor, IMU data 414, and wireless-signal-related data 416 such as the RSS thereof for object positioning. Although not shown in FIG. 14, the LBS feature map 142 in some embodiments may also comprise a motion dynamic constraint model,

During object positioning and site mapping, the processing structure 122 uses the wireless-signal-related data 416 and the wireless data model 410 for wireless data processing 418. The result of wireless data processing 418 may be used for wireless output 424 for further analysis and/or use.

The processing structure 122 also uses the IMU data 414, the IMU error model 406, the result of wireless data processing 418, and optionally the absolute special constraints 408 for generating an intermediate navigation solution 420 stored in a buffer of the memory. The processing structure 122 then applies relative constraints 428 to the buffered navigation solutions 420 (if there are more than one intermediate navigation solutions 420 in the buffer) and generates an integrated navigation solution 426 for output. The integrated navigation solution may be used for LBS feature map updating 432. Here, the relative constraints 428 are constraints between states of buffered navigation solutions 420 (described in more detail later).

Moreover, the processing structure 122 uses the images 412, the image parametric model 404, and the buffered navigation solution 420 for SLAM formulation 422. One or more sets of relative constraints 428 which may be derived from the buffered navigation solution 420, are also used for SLAM formulation 422. Herein, the relative constraints 428 are constraints that are related to the movable object's previous states and do not (directly) relate to any absolute position fixing such as sensors deployed at fixed locations of the site 102.

The SLAM formulation 422 is further optimized 430. The optimized SLAM formulation generated at step 430 forms the SLAM output 434. The optimized SLAM formulation is also fed to the navigation solution buffer 420. The relative constraints 428 are also updated in optimization 430 and the updated relative constraints 428 are fed to the navigation solution buffer 420.

Those skilled in the art will appreciate that integrated navigation solution output 426 comprise a full set of navigation data for object positioning and LBS feature map updating. On the other hand, the wireless output 424 and the SLAM output 434 are subsets of the integrated navigation solution output 426, and are optional. The two outputs 424 and 434 are included in FIG. 14 for adapting to navigation clients who only require such subsets and do not need the complete set of navigation data in navigation solution 426.

As described above, relative constraints 428 are used and also updated during SLAM formulation 422 and optimization 430. Following is a description of a process of the enhanced SLAM using and updating relative constraints 428, starting with a brief description of a conventional SLAM process for the purpose of comparison.

In some embodiments, the LBS feature map 142 may comprise one or more error models for other suitable sensors such as magnetometer, barometer, and/or the like.

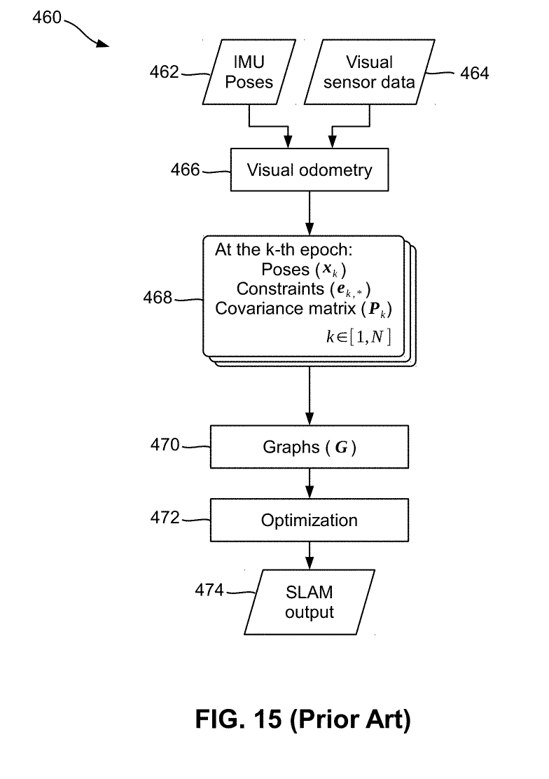

FIG. 15 is a flowchart showing a conventional SLAM process 460 using IMU and vision sensor. The detail of the conventional SLAM may be found in the academic paper entitled “A Tutorial on Graph-Based SLAM”, by Giorgio Grisetti, Rainer Kummerle, Cyrill Stachniss, and Wolfram Burgard, published in IEEE Intelligent Transportation Systems Magazine, Volume 2, Issue 4, winter 2010, the content of which is incorporated herein by reference in its entirety.

As shown, the IMU poses 462 (which are generated from raw IMU data) and vision sensor data 464 are fed into a visual odometry (step 466). The processing structure 122 then uses the visual odometry 466 to track movable objects and generate/update a map of the site at a plurality of epochs.

At the k-th epoch, k=1, 2, . . . , N, the processing structure 122 generates the pose states xₖ, a set of constraints e_{k,*} between the k-th epoch and another epoch (denoted in the subscript thereof using the symbol “*”), and a covariance matrix Pₖ of the pose states (step 468).

For each epoch, the image/vision sensor will produce the pose states xₖ, [p, a], and the corresponding matrix Pₖ, where p and a represents the vectors for position and attitude, respectively. When there is a motion in the site, either the odometry model or other motion model can be used to propagate the pose states to the (k+1)-th epoch for generating xₖ₊₁ and the corresponding covariance matrix Pₖ₊₁. The relative change in those two states xₖ and xₖ₊₁ are encoded in an edge e_{k,k+1}, which is often expressed as misclosure z_{k,k+1} and information matrix Ω_{k,k+1}. With all the pose states and edges, a graph G is constructed, and a suitable sparse optimization method can be used in order to estimate the pose states and map states. The vision sensors can help detect loop closures in order to re-adjust or estimate the pose states and map states.

At step 470, the processing structure 122 uses all generated pose states xₖ, constraints e_{k,*}, and covariance matrices Pₖ of the pose states xₖ to generate a graph G. The generated graph G is optimized (step 472) for forming the SLAM output 474.

In practice, a common challenge in using SLAM for large areas is the existence of long time periods with insufficient vision or image features. Wrong loop-closure detections can easily make the location and mapping erroneous. Although inertial sensors may be used to make reliable prediction during the vision/image sensor outages, there still exists a high probability of sensor errors and drifting that makes the SLAM solution less useful.

FIG. 16 is a flowchart showing an enhanced SLAM process 500 that uses and updates relative constraints in navigation. Similar to the prior-art SLAM process 460, the IMU poses 462 and vision sensor data 464 are fed into a visual odometry (step 466) for generating the pose states xₖ of the object being tracked, constraints e_{k,*}, and covariance matrices Pₖ at the k-th epoch, k=1, 2, . . . , N (step 468), where N is a positive integer.

The processing structure 122 also uses raw IMU data 512, motion constraints 514, and/or localization results 516 of other or external object positioning systems (if available) for IMU calibration 518 which evaluates sensor errors Sₚ, p=1, 2, . . . , M and M being a positive integer, at the p-th epoch (step 520). At step 522, the sensor errors Sₚ are combined with the raw IMU data 512 for obtaining calibrated or error-compensated IMU data 522.

At step 524, the calibrated IMU data 522 is used for generating a plurality of parameters for each epoch such as navigation states Φₚ, motion models Mₚ, and covariance matrix Pₚ of the navigation state Φₚ at the p-th epoch. As those skilled in the art will appreciate, the navigation state Φₚ comprises a variety of parameters such as poses, velocity, position, and the like.

The processing structure 122 then uses the navigation states Φₚ and Φ_{q}, motion models Mₚ and M_{q}, covariance matrices Pₚ and P_{q}, and sensor errors Sₚ and S_{q} at the p-th and q-th epochs to calculate calibrated state parameters such as the poses x_{s,p} and x_{s,q}, relative constraints e_{p,q}, covariance matrices Pₚ and P_{q}, and an information matrix Ω_{p,q} (step 526).

At this step, the integrated navigation solutions can be used to derive the relative constraints. The navigation state for the p-th epoch is x_{nav,p}, the corresponding covariance matrix is P_{nav,p}, and

x_{nav,p}=[p_{nav,p}, v_{nav,p}, a_{nav,p}, b_{nav,p}, s_{nav,p},], (1)

where p_{nav,p}, v_{nav,p}, a_{nav,p}, b_{nav,p}, and s_{nav,p} are the vectors for position, velocity, attitude, sensor biases, and sensor scale factor errors, respectively.

The navigation state for the q-th epoch updates the navigation solution, and the corresponding state covariance is P_{nav,p}. As navigation solution states are generally large, data processing is time-consuming especially when sensor data with high data rates (such as IMU sensor data) are fed to the system 100. Conventional navigation solution uses Rauch-Tung-Striebel smoother (RTS) for forward and backward smoothing, which is not flexible and only sequential relative constraints are applied.

In this convention, selected relative constraints can be added to graph optimization to improve the pose estimation. For example, when the estimated states' variance such as position variance are both below a predefined threshold, one can claim a valid relative constraint between these two epochs p, q. The edge (misclosure and information matrix) can be computed accordingly which can be used later for sparse optimization. For instance, the position and attitude in the buffered navigation solution will be used to compute the misclosure and information matrix. The misclosure can be

z_{p,q}=x_{s,p}−x_{s,q}, (2)

and one way to compute the corresponding information matrix is

Ω_{p,q}=(Pₜₕ+Q_{p,q})⁻¹, (3)

where Pₜₕ is the covariance threshold for both epochs, and Q_{p,q} is the noise propagation matrix (position random walk models for position states, and angular random walk model for attitude states) between epochs, if it is of the same system update, then Q_{p,q} can be set as a very small value. With the graph constructed, sparse optimization can be used to reliably estimate the corresponding pose and map states.

Referring back to FIG. 16, at step 528, the results obtained at steps 468 and 526 are combined for re-adjusting the constraints according to a cost function F(\vec{x}_{[1:N]}, \vec{e}_{[1:N],*}, \vec{P}_{[1:N]}, \vec{x}_{s,[1:M]}, \vec{e}_{s,[1:M],*}, \vec{P}_{[1:M]}), where the symbol \vec{w}_{[1:K]} represents arranging all wₖ, k=1, 2, . . . , K into a vector (or matrix) form, and \vec{w}_{[1:K],*} represents arranging all w_{k,*}, k=1, 2, . . . , K into a vector (or matrix) form.

At step 530, the re-adjusted constraints are used for calculating calibrated pose states \tilde{x}ₖ, constraints \tilde{e}_{k,*}, and covariance matrices \tilde{P}ₖ at the k-th epoch, k=1, 2, . . . , N, which are used for generating calibrated graphs \tilde{G} (step 532). Similar to the conventional SLAM process 460, the calibrated graphs \tilde{G} are optimized (step 534) and output as SLAM output 536. The calibrated constraints \tilde{e}_{k,*} are used as updated relative constraints.

In some embodiments, the processing structure 122 uses the LBS feature map for spatial path matching. Hereinafter, a “navigation path” is a traversed geographic trajectory which is formed by sequential navigation solution outputs. A navigation path may be a partially determined navigation path wherein some characteristics thereof such as the starting point thereof, may be known from the analysis of sensor data and/or previous navigation results. However, the location of the partially-determined navigation path in the site 102 may be unknown, and therefore needs to be determined. Hereinafter, the partially-determined navigation path and the determined navigation path may be both denoted as a “navigation path”, and those skilled in the art would readily understand its meaning based on the context.

A candidate path or possible path is a sequence of connected links in the LBS feature map 142. There may exist a plurality of candidate paths with a same starting point as the partially-determined navigation path. The system 100 then needs to determine which of the plurality of candidate paths matches the partially-determined navigation path and may be selected as the determined navigation path. After all characteristics of the partially-determined navigation path are determined, the partially-determined navigation path becomes a determined navigation path.

As shown in FIG. 17, the LBS map 142 comprises spatial information encoded as a spatial connectivity structure. For example, node n₃₃ is only accessible from nodes n₂₄, n₂₅, n₃₆, and n₃₇. Node n₂₅ only connects with nodes n₂₃, n₃₂, and n₃₃. The link between node i and node j is denoted as l_{i,j}. For example, the link between nodes n₃₇ and n₄₇ is l_{37,47}. For a given region, there are limited numbers of such paths. One method to determine the possible profiles (or trajectories) in a region is based on maximum likelihood estimation, which enumerates all possible paths.

In these embodiments, the processing structure 122 executes a process for spatial path matching based on the LBS feature map 142. The process comprises the following steps:

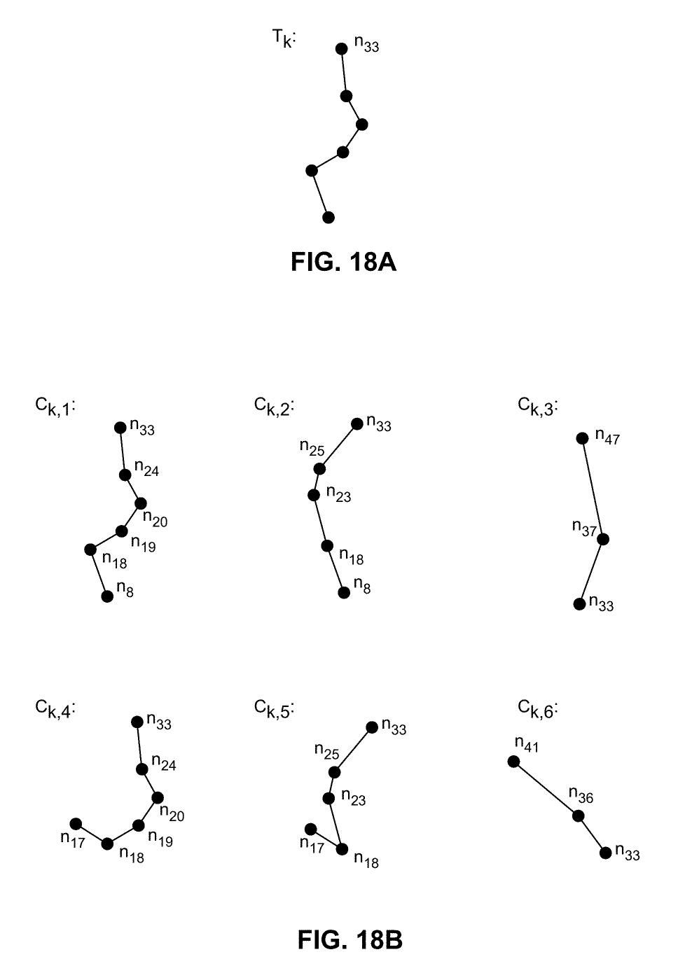

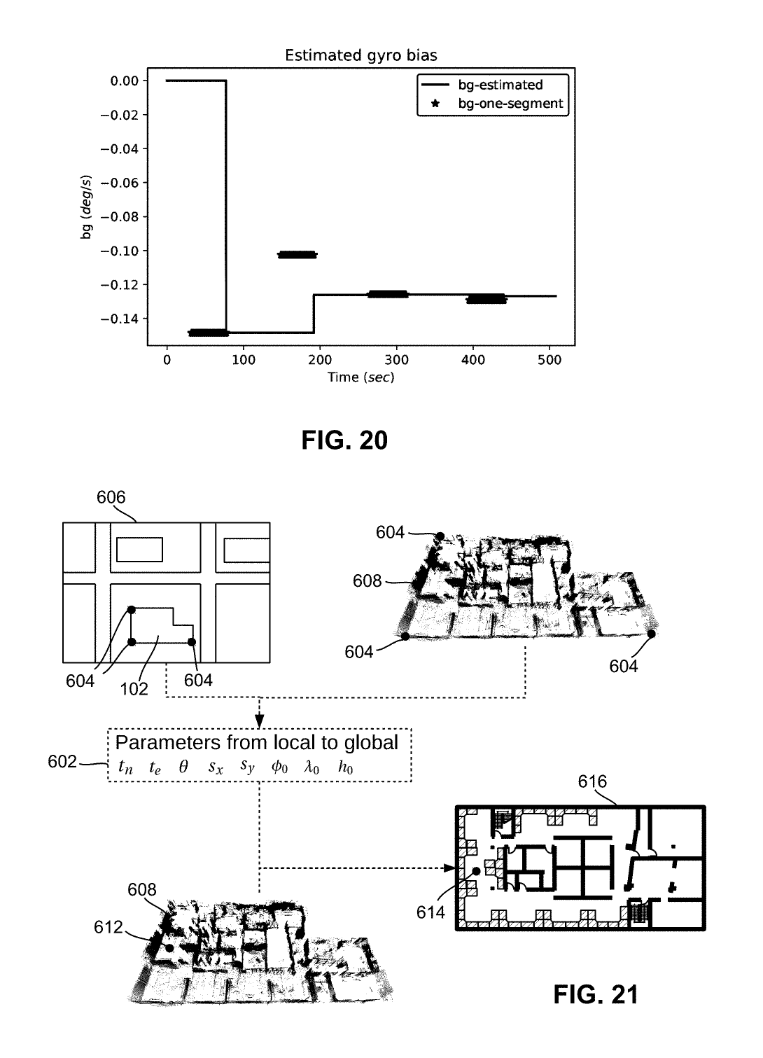

(B-i) Retrieve the (partially-determined) navigation path from the navigation buffer 664 (see FIG. 20).
The navigation path is illustrated as Tₖ in FIG. 18A and may be a relative path since some systems (for example, INS, PDR, and SLAM) only determine relative positions. Moreover, the navigation path Tₖ is a partially determined navigation path as the characteristics of the navigation path Tₖ are partially known, and some characteristics such as the location of the navigation path Tₖ on the map 142 need to be determined.

(B-ii) Calculate the traversed distance of the navigation path Tₖ by accumulating the geographical distances between adjacent position states.

(B-iii) Find all candidate paths from the LBS feature map 142 using available constraints.
Referring to FIG. 17, if the starting point for searching is fixed at n₃₃, a number of possible paths starting from node n₃₃ can be found under available constraints such as having an accumulated length or distance similar to the traversed distance from node n₃₃ (e.g., within a predefined distance-difference threshold). For example, six possible paths are found including:
   C_{k,1}: n₃₃→n₂₄→n₂₀→n₁₉→n₁₈→n₈,
      C_{k,2}: n₃₃→n₂₅→n₂₃→n₁₈→n₈,
         C_{k,3}: n₃₃→n₃₇→n₄₇,
   C_{k,4}: n₃₃→n₂₄→n₂₀→n₁₉→n₈→n₁₇,
      C_{k,5}: n₃₃→n₂₅→n₂₃→n₁₈→n₁₇,
         C_{k,6}: n₃₃→n₃₆→n₄₁.
The conditions used for selecting a possible path include: (a) the links on the path are connected and accessible and (b) the traversed length of the path is close to the partially-determined navigation path Tₖ. FIG. 18B shows the possible paths C_{k,1} to C_{k,6}.

(B-iv) Calculate the similarity between the partially-determined navigation path Tₖ and each candidate path C_{k,1}, i=1, 2, . . . , and select the one having the highest similarity to the determined navigation path. Herein, the similarity may be geographic similarity and/or similarity of the sensor data and/or LBS feature between the partially-determined navigation path Tₖ and each candidate path C_{k,1}.

If the navigation solution is provided by absolute positioning techniques such as wireless localization, the partially-determined navigation path and candidate paths can be directly compared. Otherwise, if the partially-determined navigation path is a relative path, operations such as rotation and translation may be needed before comparisons are made.

A suitable maximum likelihood method may be used when translation and rotation are required. For example, as shown in FIGS. 18A and 18B, it is straightforward to enumerate other possibilities for the partially-determined navigation path. For example, given an angular sample spacing α (for example 30°), 360°/α (for example 12 for α=30°) rotations can be searched. In 2D translation, initial uncertainty can be used to align the starting points of the partially-determined navigation path and each candidate path, which also affects the similarity metrics between the two paths.

One method to compare the similarity between two paths is to equally divide both paths to N segments and then compare the paths. For example, each path may comprise N+1 endpoints with each endpoint having its own (x, y) coordinates. Then, the candidate and partially-determined navigation paths can generate two location sequences of coordinates. One method to compute the similarity between the two location sequences is to directly calculate the correlation thereof and select one or more candidate paths with the highest similarities as possible navigation path, among which the candidate path having the highest similarity may be the most likely (determined) navigation path.

In some embodiments, the processing structure 122 executes a process for efficiently applying spatial constraints for magnetometer-based fingerprinting.

Unlike the standard fingerprinting algorithm, the process in these embodiments is based on the spatial information encoded in the LBS map, in which the LBS features and location keys have already been paired. Once a sequence of locations is selected, the LBS feature sequence can be generated accordingly and used for profile-based fingerprinting such as profile-based magnetic fingerprinting.

Herein, a profile may represent a sequence of LBS features for example, wireless signals (such as their mean values) and/or magnetic field anomalies. The term “measured magnetic fingerprint/anomalies profile” refers to a sequence of magnetic fingerprints/anomaly measured along a spatial trajectory. Each individual magnetic anomaly/fingerprint is associated with a respective position in the site 102. A candidate magnetic anomaly/fingerprint profile represents a sequence of magnetic anomaly/fingerprints associated with a candidate path.

The process for profile-based magnetic fingerprinting may comprise the following steps:

(C-i) obtain a partially-determined navigation path, and an measured magnetic fingerprint profile which may comprise the measured magnetic intensity norm, horizontal magnetic intensity, vertical magnetic intensity, and/or the like along the partially-determined navigation path;

(C-ii) store the partially-determined navigation path and the measured magnetic fingerprint profile into two processing buffers;

(C-iii) generate candidate paths in the LBS feature map under suitable initial conditions such as a starting point, and generate candidate magnetic fingerprint profiles associated with the candidate paths;

(C-iv) compute the similarity between the magnetic fingerprint profiles of the partially-determined navigation path and each candidate path; and

(C-v) find the determined navigation path based on the similarities between the magnetic fingerprint profiles of the partially-determined navigation path and candidate paths.

The magnetic features obtained from the LBS feature map may include mean and variance values of the magnetic intensity norm, horizontal magnetic intensity, and vertical magnetic intensity. At step (C-ii) above, the mean values are used to generate the possible magnetic profiles.

When calculating the observation profile similarity at step (C-iv), the processing structure 122 loads the LBS feature sequences from the LBS feature map and may interpolate the loaded LBS feature sequences to ensure that the observed and feature profiles have a same length of epochs.

At time t(k), the partially-determined navigation path having a length of N+1 epochs may be expressed as p_{k-N}, p_{k-N+1}, . . . , pₖ₋₁, pₖ and its corresponding measured magnetic profile can be expressed as [m_{k-N}, m_{k-N+1}, . . . , mₖ₋₁, mₖ] where pᵢ and mᵢ represent the position and magnetic features on the i-th epoch, respectively. If M+1 (M<N) is the total number of epochs/points along a candidate path in the LBS feature map, the candidate path in LBS feature map is then p_{c,t-M}, p_{c,t-M+1}, . . . , p_{c,t-1}, p_{c,t} and the corresponding candidate magnetic profile associated therewith is [m_{c,t-M}, m_{c,t-M+1}, . . . , m_{c,t-1}, m_{c,t}], where the subscript t indicates the starting point of the candidate path. The 2D interpolated vector [m_{c,t-N}, m_{tc,-N+1}, . . . , m_{c,t-1}, m_{c,t}] can be computed by using suitable kernel methods such as Gaussian process models from the candidate magnetic profile [m_{c,t-M}, m_{c,t-M+1}, . . . , m_{c,t-1}, m_{c,t}]. After interpolation, the re-sampled candidate path and candidate magnetic profile become:
[P_{c,t-N}, P_{c,t-N+1}, . . . , P_{c,t}],
[m_{c,t-N}, m_{c,t-N+1}, . . . , m_{c,t}].

The interpolated candidate magnetic profile [m_{c,t-N}, m_{c,t-N+1}, . . . , m_{c,t}] is then compared with the measured magnetic profile [m_{k-N}, m_{k-N+1}, . . . , mₖ₋₁, mₖ] and the likelihood for the candidate magnetic profiles can be calculated by:

$$P = {\sum }_{i = 0}^{N} \frac{\frac{1}{{σ}_{1}^{2}}}{{\sum }_{j = 0}^{N} \frac{1}{{σ}_{j}^{2}}} {P}_{m , i} , \qquad ( 4 )$$

where the subscript i indicates one fingerprint on the profile. The calculation of the likelihood on each single fingerprint is similar to traditional single-point matching. The terms σᵢ² and σⱼ² are the accuracies/uncertainties of the measured magnetic profile at the i-th and j-th positions on the partially-determined navigation path, respectively, and P_{m,i} is the likelihood or similarity value between the measured magnetic profile and the candidate magnetic profile at the i-th position, i.e., the likelihood or similarity between pₖ₋ᵢ and p_{c,t-i}.

After the likelihood values for all the candidate profiles are calculated and sorted, the maximum likelihood solution of profile-based fingerprinting is thus determined as the candidate path whose candidate magnetic profile having the highest likelihood. The overall likelihood for above-mentioned profile matching depends on two factors: (a) the likelihood for each fingerprint on the profile based on its model and (b) the accuracy of that location for the profile feature. That is, given a location, there is a model with statistics (for example, mean and variance values) of the magnetic feature such as norm, horizontal, and vertical magnetic intensities. The location accuracy at each epoch along the navigation path is obtained from the navigation solution.

In one embodiment, PDR is used to generate the measured profile which will only propagate the covariance matrix, and both heading and accumulated step-length errors grow linearly over time. Thus, the position uncertainty increases quadratically with time. The location accuracy then weights the impact from each fingerprint on the profile. Fingerprints corresponding to points with larger position-uncertainty have less impact on the calculation of the likelihood for the profile. Compared with traditional localization methods, the profile-based fingerprinting method described herein fully utilizes the spatial structure from the LBS feature map, and thus has a much lower probability to obtain an incorrect match.

In some embodiments, the processing structure 122 executes a process for heading alignment and heading constraining. The method is especially useful for dead-reckoning-based navigation solution.

Dead-reckoning methods are often based on self-contained IMU and may provide reliable short-term navigation states without external information such as wireless signals or GPS signals. However, dead-reckoning may suffer from two challenging issues including heading alignment and heading drifting. Herein, alignment refers to heading initialization while other states may also need to be initialized.

In traditional dead-reckoning, the default initial velocity may be set to zero. The initial position is commonly obtained from external techniques such as BLE-based or WI-FI®-based positioning or by using a particle filter method. The initialization of horizontal angles (pitch and roll) may be directly calculated from the accelerometer data. However, the initialization of heading may be challenging.

Theoretically, magnetometers may be used to provide an absolute heading through the following steps:

(D-i) use accelerometer-derived roll and pitch angles to levelling the magnetometer measurements. At this step, the horizontal magnetic data m_{hx,k} and m_{hy,k}, can be calculated as:

m_{hx,k}=m_{x,k} cos θₖ+m_{y,k} sin φₖ sin θₖ+m_{z,k} cos φₖ sin θₖ, (5)

m_{hy,k}=m_{y,k} cos φₖ−m_{z,k} sin φₖ, (6)

where m_{x,k}, m_{y,k}, and m_{z,k} are the x-, y-, and z- axis magnetometer measurements, θₖ is the pitch angle, and φₖ is the roll angle. The horizontal magnetic data m_{hx,k} and m_{hy,k} are then used for levelling the magnetometer measurements.

(D-ii) use the levelled magnetometer measurements to calculate the magnetic heading ψ_{mag,k} which is the heading angle from the Earth's magnetic north, and then calculate the true heading ψₖ which is the heading angle from the Earth's geographic north, by adding a declination angle Dₖ to the magnetic heading ψ_{mag,k}, i.e.,

$${ψ}_{k} = {ψ}_{mag , k} + {D}_{k} = {tan}^{- 1} ( \frac{{m}_{hy , k}}{{m}_{hx , k}} ) + {D}_{k} . \qquad ( 7 )$$

This approach is developed based on the precondition that the local magnetic field is the Earth geomagnetic field, and thus the value of the declination angle can be obtained from the International Geomagnetic Reference Field (IGRF) model. However, the local magnetic field was susceptible to magnetic anomalies from man-made infrastructures in indoor or urban environments. Hence, such magnetic interferences cause a critical issue in using magnetometers as a compass in an indoor environment because it is difficult to obtain the accurate value of the declination angle in real time in such an environment.

In these embodiments, the magnetic declination angle has been stored in the LBS feature map as a location-dependent LBS feature. Thus, a magnetic declination angle model containing the mean and variance values of the magnetic declination angle may be readily obtained from the LBS feature map by using a location key. The mean value thereof may be used to compensate for the magnetic declination angle and the variance value thereof may be used as the uncertainty of the initial heading after the declination angle compensation.

Since magnetic data is a signal of opportunity and has a low dimension, the uncertainty of the compensated initial heading may still be large. Thus in these embodiments, a spatial structure from the LBS feature map is used to further enhance the calculation of the heading. In this step, relative heading changes and the magnetic anomaly are used as the LBS features and a profile matching is conducted. The likelihood values for all candidate profiles are calculated and sorted. Then, one or more profiles with highest likelihood values are selected.

In one embodiment, a maximum likelihood estimation is used for selecting the one or more profiles with highest likelihood values, in which the estimated heading may be selected as the solution with the largest likelihood.

In another embodiment, the heading solution based on magnetic matching may be obtained by be calculating a weighted average of a plurality of selected heading solutions such as a plurality of heading solutions with highest likelihood values (i.e., their likelihood values are higher than those of all other heading solutions). The calculated likelihood of each selected heading solution is used as its weight.

When the movable object 108 starts to move, the measurement profile is updated by a fixed-length run-time buffer, which maintains a fixed number of most-recent observations, and profile matching results may be continuously derived. The heading solution obtained from profile matching can be used as the initial heading and may also be used for providing a heading constraint. The heading update model is

\tilde{ψ}ⁿ−\tilde{ψ}_{profile}ⁿ=δψⁿ+n_{ψ, profile}, (8)

where \tilde{ψ}ⁿ is the heading predicted by the sensor data processing, \tilde{ψ}_{profile}ⁿ is the heading obtained from profile matching, δψⁿ is the heading error and n_{ψ,profile} is the heading measurement noise.

In some embodiments, the processing structure 122 executes a process for reliably estimating gyro bias or error in complex environments. In these embodiments, the gyro bias/error is estimated by using the graph-optimized pose states sequences. When it is detected that the movable object 108 has passed two links (or pass the same link twice) in the LBS feature map, the difference between the heading angles of the two links can be used to build a relative constraint which may be used even when the navigation states estimation is not satisfactory. For example, in the scenario that a movable object 108 moves in a building that has no wireless signals and thus has no absolute position fixing, PDR may be the only method for position tracking.

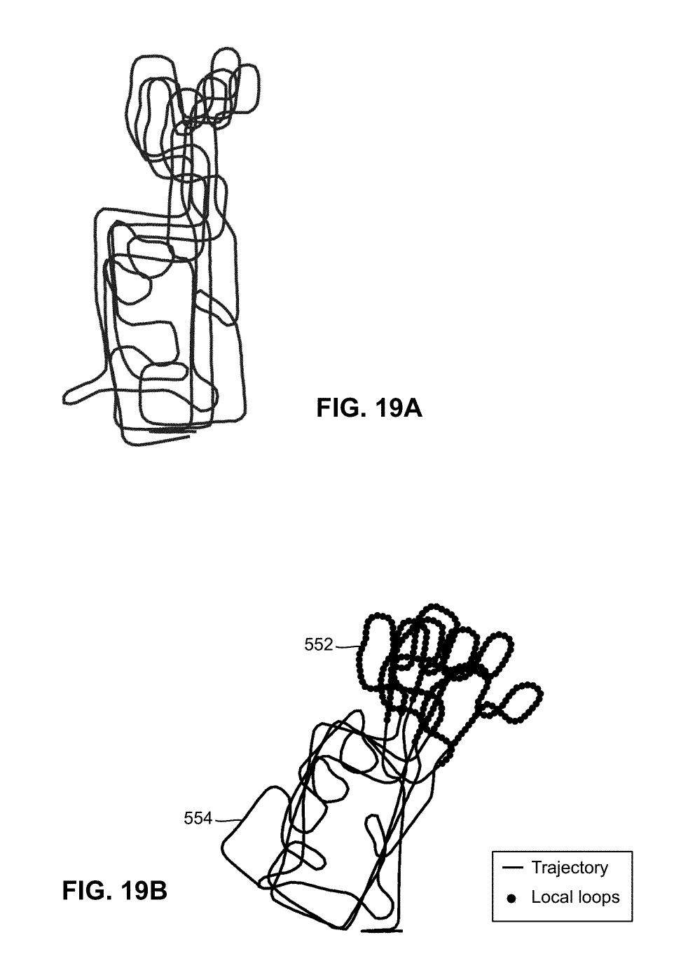

FIG. 19A shows the calculated trajectory of a movable object 108 in the site 102 using IMU and the LBS feature map. In comparison, FIG. 19B shows the calculated trajectory of the movable object 108 without using any LBS feature map. As can be seen from FIG. 19B, the heading drifts due to the vertical gyro bias.

With the LBS feature map, a hallway structure connecting the top local loops 552 (see FIG. 19B) and bottom local loops 554 can be used as a relative constraint. Specifically, by using the above-described methods of spatial path matching based on LBS feature map, the system 100 may detect that the movable object 108 has passed the hallway connecting the top local loops 552 and the bottom local loops 554 for several times.

A method of using such a relative constraint (the hallway structure in above example) is based on the fact that the error in the calculated heading is caused by the vertical gyro bias. For example, if the user passes the hallway with a direction from the area (also identified using reference numeral 554) of the bottom local loops 554 to the area (also identified using reference numeral 552) of the top local loops 552 at time t₁ and passes the hallway with a direction from the area 552 to area 554 at time t₂, the relative constraint can be written as

Δ\hat{ψ}−Δ\tilde{ψ}=(t₂−t₁)b_{g}+n_{b}_{_{g}}, (9)

where Δ\hat{ψ} is the heading change calculated by the accumulation of the vertical gyro outputs over time, Δ\tilde{ψ} is the reference value for the heading change (which is 180° in this example), b_{g} is the vertical gyro bias, and n_{b}_{_{g}} is the measurement noise. With this relative constraint, the graph optimization may generate a few attitude updates to the original navigation solution, which re-estimates the vertical gyro bias and improves the navigation solution. This constraint is used when |Δ\hat{ψ}−Δ\tilde{ψ}|<180°, where |x| represents the absolute value of x. FIG. 20 shows a PDR gyro bias estimation result. In this figure, the bold line segments illustrated the gyro bias estimated by one data segment, and the thin line represents the gyro bias estimated by using data from all previous data segments. FIG. 19A shows the trajectory of a LBS feature map enhanced PDR with re-estimated the gyro bias.

In some embodiments, the processing structure 122 executes a process for wireless multilateration enhanced by the LBS feature map.

Wireless RSSI measurements fluctuate due to factors such as obstructions, reflections, and multipath effect, and the wireless data model of a gateway or access point may vary from one area/region to another. Therefore, larger-area model may be more accurately represented by a plurality of smaller-areas models. In these embodiments, the wireless data models are stored as location-dependent LBS features in the LBS feature map.

In these embodiments, a multi-hypothesis wireless localization method is used. Each hypothesis computes wireless localization using one set of candidate data models for one region. A suitable hypothesis testing method such as general likelihood ratio test (GLRT) may be used to determine the estimation location.

Below describes an example of position determination for a single hypothesis. In a target region t-th epoch, the RSSI observations are processed and used to build a design matrix Hₜ having 10 observations, and an observation matrix Zₜ as:

$$\begin{matrix}\begin{matrix}{H}_{t} = {[ {H}_{t , 1} {H}_{t , 2} … {H}_{t , 10} ]}^{T} , \\ {H}_{t , k} = [ - \frac{{x}_{t , k} - {x}_{r}}{{d}_{t , k}} - \frac{{y}_{t , k} - {y}_{r}}{{d}_{t , k}} - \frac{{z}_{t , k} - {z}_{r}}{{d}_{t , k}} ] ,\end{matrix} \\ & ( 10 ) \\ {Z}_{t} = {[ {ρ}_{t , 1} - {d}_{t , 1} {ρ}_{t , 2} - {d}_{t , 2} … {ρ}_{t , 10} - {d}_{t , 10} ]}^{T} , & ( 11 ) \\ {ρ}_{t , k} = {10}^{\frac{{RSSI}_{t , k} - {b}_{mean , t , k}}{- 10 {n}_{mean , t , k}}} , & ( 12 ) \\ {d}_{t , k} = \sqrt{{( {x}_{t , k} - {x}_{r} )}^{2} + {( {y}_{t , k} - {y}_{r} )}^{2} + {( {z}_{t , k} - {z}_{r} )}^{2}} , & ( 13 )\end{matrix}$$

where (x_{t,k}, y_{t,k}, z_{t,k}) is the user position, which is determined recursively. The state vector to be estimated is xₜ=[xᵣ yᵣ zᵣ]. Using the least square method, the state vector is estimated as \hat{x}ₜ=Hₜ^{T}Rₜ⁻¹Hₜ)⁻¹Hₜ^{T}Rₜ⁻¹Zₜ, and its covariance matrix is calculated as Pₜ=(Hₜ^{T}Rₜ⁻¹Hₜ)⁻¹, where Rₜ is a diagonal matrix, in which the i-th diagonal element is calculated by b_{var,t,k}RSSI_{t,k}/Σₖ₌₁¹⁰(b_{var,t,k}RSSI_{t,k}), which indicates observation from a gateway that has a larger RSSI value or has a larger variance in its data model will have less weight in the least square calculation.

The calculated covariance matrix determines an ellipse that indicates the uncertainty of the localization solution in this hypothesis. The major and minor semi-axis of the ellipse are

$$\begin{matrix}a = \sqrt{0.5 ( {σ}_{N}^{2} + {σ}_{E}^{2} ) + \sqrt{0.25 ( {σ}_{E}^{2} - {σ}_{N}^{2} ) + {σ}_{NE}^{2}}} , & ( 14 ) \\ b = \sqrt{0.5 ( {σ}_{N}^{2} + {σ}_{E}^{2} ) - \sqrt{0.25 ( {σ}_{E}^{2} - {σ}_{N}^{2} ) + {σ}_{NE}^{2}}} , & ( 15 )\end{matrix}$$

respectively, and the angle between the major semi-axis and the north is θ=0.5 tan⁻¹2σ_{NE}/(σ_{E}²−σ_{N}²), where σₙ²=Pₜ(1,1), σ_{E}²=Pₜ(2,2), and σ_{NE}=Pₜ(1,2) are the elements in the covariance matrix.

In some embodiments, the processing structure 122 executes a process of using digital elevation model (DEM) compensated motion model constraints in navigation. A PDR algorithm comprises three parts: step detection, step-length estimation, and step heading estimation. In step detection, the pedestrian steps can be detected by using the accelerometer and gyro signals. In step-length estimation, the walking frequency and the variance of the accelerometer signals may be estimated by using a linearized step-length model such as SLₖ=cos θ(α·fₖ+β·dₖ+γ), where SLₖ represents the step-length, θ is the ramp angle corresponding to the current location obtained from the LBS feature map, fₖ=1/(tₖ−tₖ₋₁) and dₖ=Σₜ₌ₖ_{_{k−1}}^{t}^{ₖ}((aₜ−āₖ)²/N), where fₖ and dₖ are the walking frequency and the acceleration variance, respectively, aₜ is acceleration, āₖ and N are the mean value and the number of accelerations during the time period [tₖ₋₁, tₖ], respectively. α, β, and γ are the parameters which may to be pre-determined during a pre-calibration stage.

In some embodiments, the processing structure 122 executes a process of generating a skeleton of the environment which depends on spatial structure and observation distribution.

A spatial structure skeleton may be generated using a Voronoi diagram. As shown in FIG. 8, a spatial-alone skeleton can be generated by using Voronoi diagram or similar methods from a 2D vector map. The 2D vector map can be obtained from image/point cloud processing or occupancy mapping methods. The nodes of the skeleton may be considered as a linked list, dᵢ for i ϵ [1, K], where K is an integer representing the total number of nodes in the skeleton. The corresponding location for each node is r_{di}=(x_{di}, y_{di}). The linkage of nodes can also be stored for keeping the node connectivity information.

Given a number of raw sensor observations distributed over a region of the site 102, the system 100 may calculate the spatial distribution of such sensor observations by using various suitable spatial interpolation methods, for example, kernel-based methods or Gaussian process models (radial basis function (RBF) kernels and white kernels). Then, the mean μ(x, y) and variance σ² (x, y) of the observation distribution over the region can be inferred for example, by directly inferring μ(r_{di}) and σ²(r_{di}) with location r_{di}.

To update the skeleton with observation distribution, the system 100 may first loop over existing nodes dᵢ. For each node, the system 100 checks if there are sufficient number of observations within the corresponding region/division (for example, the number of observations within the region is less than a first threshold), and if not, the node is removed. The system 100 also checks if the number of observations is greater than a second threshold, the second threshold being greater than the first threshold, and if yes, the system 100 inserts a new node into the region. Moreover, if the variance of the observations is too large (for example, larger than a variance threshold), the system 100 removes the node from the region.

In some embodiments, the processing structure 122 executes a process of aligning local or regional LBS feature maps with a global LBS feature map or reference LBS feature map.

As it is shown in FIG. 21, a set of coordinate transformation parameters 602, i.e., [tₙ, tₑ, θ, sₓ, s_{y}, φ₀, λ₀, h₀], is first calculated, where tₙ and tₑ are the north and east translation parameters, respectively, θ is the rotation parameter, sₓ and s_{y} are the scaling parameters, and φ₀, λ₀, and h₀ are the latitude, longitude, and Geoid height of the original point for coordinate transformation. One method to calculate the coordinate transformation parameters is to select at least three calibration points 604 in the site 102 in a map 606 such as the Google Map having a global coordinate frame and corresponding calibration points 604 in the point clouds 608 or other suitable observation map having a local coordinate frame, determine the local coordinates of the calibration points 604 in the local coordinate frame of the point clouds 608, and determine the global coordinates of the calibration points 604 in the global coordinate frame of the map 606. Then, the parameters can be calculated by using least squares. The equations used for transforming a local frame to the global frame are

φ(k)*(Rₘ+h₀)=φ₀*(Rₘ+h₀)+tₙ+x(k)*sₓ*cos θ+y(k)*s_{y}*sin θ, (16)

λ(k)*(Rₙ+h₀)*cos θₖ=λ₀*(Rₙ+h₀)*cos φ(k)+tₑ+x(k)*sₓ*sin θy(k)*s_{y}*cos θ, (17)

and h(k)=h₀+z(k), where φ(k), λ(k), and h(k) are the latitude, longitude, and Geoid height of the k-th calibration point, respectively, x(k), y(k), and z(k) are the local coordinates of the k-th calibration point. Rₘ and Rₙ are the radius of curvature in the meridian and the radius of curvature in prime vertical, respectively. With the calculated coordinate transformation parameters, coordinates 612 of geo-information in the point clouds 608 and position solutions, can be transformed to coordinates 614 in the global coordinate frame 616 by using the above-disclosed equations.

In some embodiments, the processing structure 122 executes a false loop-closure rejection process of using the spatial construction in the LBS feature map for enhance the SLAM solution. If two nodes in a navigation path have generated a loop-closure, the processing structure 122 may retrieve the LBS features of the two nodes from the LBS feature map by using their locations as the keys. Then, the processing structure 122 may check the difference between the LBS features. If the difference is larger than a feature-difference threshold, the loop-closure is marked as an incorrectly-retained or false loop-closure and is rejected. In one embodiment, the feature-difference threshold is the same over all locations in the site 102. In another embodiment, the feature-difference threshold is spatial dependent and different locations in the site 102 may have different feature-difference thresholds.

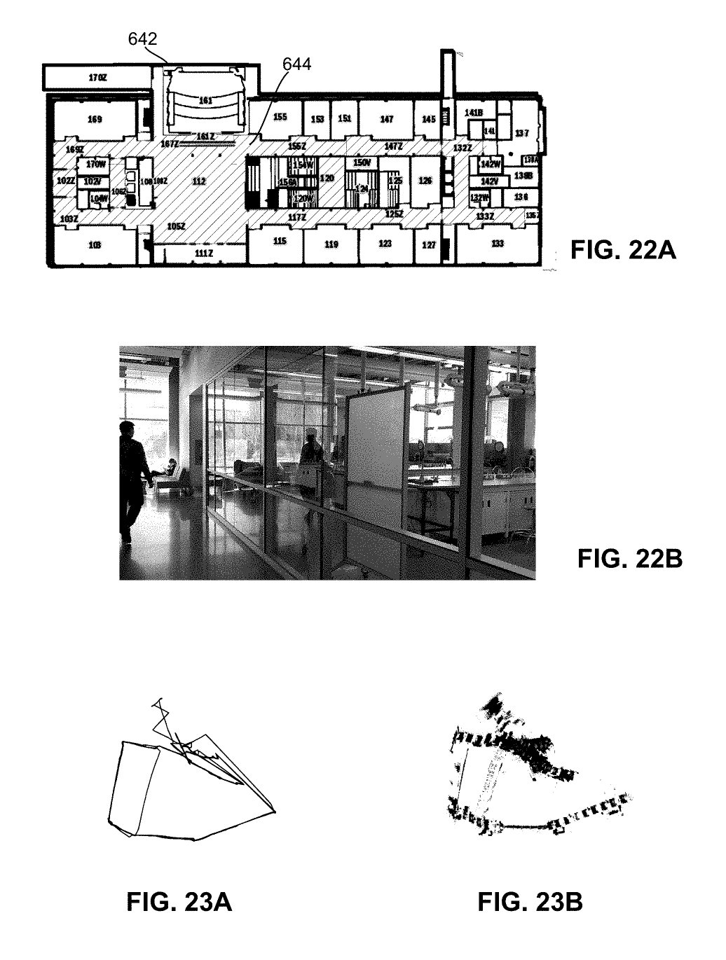

FIG. 22A shows a floor plan of a testing site 642. A survey vehicle (not shown) traverses the testing site 642 within the shaded testing area 644. As illustrated in FIG. 22B, the testing area 644 is a relatively large area with many glass walls. Therefore, strong background light through the glass walls significantly interferes the vision sensor of the survey vehicle.

FIGS. 23A and 23B show the test results of a standard SLAM positioning method without using the false loop-closure rejection process. As can be seen, the test results suffer from incorrectly retained loop-closures, and do not reflect the correct spatial structure of the testing area 644.

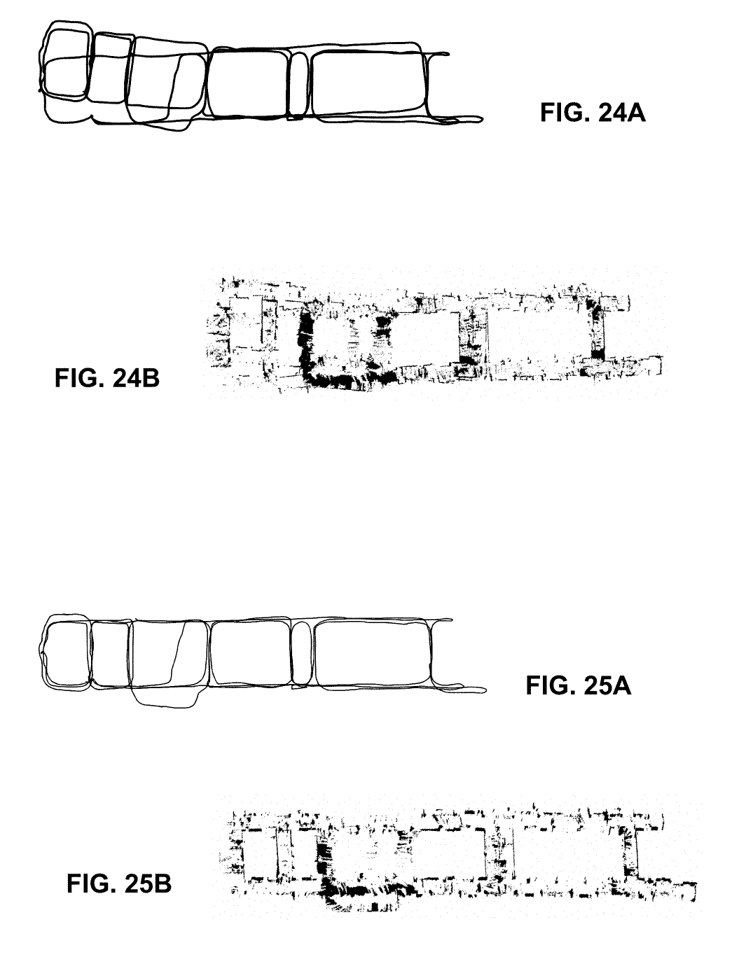

FIGS. 24A and 24B shows the test results of the standard SLAM positioning method with the use of the false loop-closure rejection process for removing incorrectly-retained loop-closures. As can be seen, the test results generally reflect the correct spatial structure of the testing area 644 with some distortions.

FIGS. 24A and 24B shows test results of the enhanced navigation solution with LBS feature map (see FIG. 16), and in particular, using the spatial structure from the LBS feature map to provide relative constraints for SLAM. As can be seen, the test results accurately reflect the correct spatial structure of the testing area 644 without significant distortions.

Although embodiments have been described above with reference to the accompanying drawings, those of skill in the art will appreciate that variations and modifications may be made without departing from the scope thereof as defined by the appended claims.

What is claimed is:

1. A system for positioning a movable object in a site, the method comprising:
a plurality of sensors movable with the movable object;
a memory; and
at least one processing structure functionally coupled to the plurality of sensors and the memory, the at least one processing structure being configured for:
collecting sensor data from the a plurality of sensors;
obtaining one or more observations based on the collected sensor data, said one or more observations spatially distributed over the site;
retrieving a portion of the location-based service (LBS) features from a LBS feature map of the site, the LBS feature map stored in the memory and comprising a plurality of LBS features each associated with a location in the site; and
generating a first navigation solution for positioning the movable object at least based on the one or more observations and the retrieved LBS features, said first navigation solution comprising a determined navigation path of the movable object and parameters related to the motion of the movable object;
wherein the plurality of LBS features in the LBS feature map are spatially indexed.

2. The system of claim 1, wherein the LBS feature map comprises at least one of an image parametric model, an inertial measurement unit (IMU) error model, a motion dynamic constraint model, and a wireless data model.

3. The system of claim 1, wherein the at least one processing structure is further configured for:
obtaining one or more navigation conditions based on the one or more observations; and
wherein said retrieving the portion of the LBS features from the LBS feature map comprises:
determining the portion of the LBS features in the LBS feature map based on the one or more navigation conditions.

4. The system of claim 1, wherein the at least one processing structure is further configured for:
extracting a spatial structure of the site based on the observations;
simplifying the spatial structure into a skeleton, the skeleton being represented by a graph comprising a plurality of nodes and a plurality of links, each of the plurality of links connecting two of the plurality of nodes;
calculating a statistic distribution of the observations over the site;
adjusting the graph based on at least geographical relationships between the nodes and links and the statistic distribution of the observations;
fusing at least the adjusted spatial structure and the observation distribution for obtaining updated LBS features; and
associating the updated LBS features with respective locations for updating the LBS feature map.

5. The system of claim 4, wherein said adjusting the graph based on the at least geographical relationships between the nodes and links and the statistic distribution of the observations comprises at least one of:
merging two or more of the plurality of nodes in a first area of the site and removing the links therebetween if the number of samples of the observations in the first area is smaller than a first predefined number-threshold; and
adding one or more new nodes and links in a second area if the number of samples of the observations in the second area is greater than a second predefined number-threshold.

6. The system of claim 1, wherein said generating the first navigation solution comprises:
generating a second navigation solution and storing the second navigation solution in a buffer of the memory;
if there exist more than one second navigation solutions in the buffer, applying a set of relative constraints to the more than one second navigation solutions for generating the first navigation solution for positioning the movable object; and
updating the LBS feature map using the first navigation solution.

7. The system of claim 1, wherein said generating the first navigation solution comprises:
determining a first navigation path of the movable object based on the observations, said first navigation path having a known starting point;
calculating a traversed distance of the first navigation path;
determining a plurality of candidate paths from the LBS feature map, each of the plurality of candidate paths starting from said known starting point and having a distance thereof such that the difference between the distance of each of the plurality of candidate paths and the traversed distance of the first navigation path is within a predefined distance-difference threshold;
calculating a similarity between the first navigation path and each of the plurality of candidate paths; and
selecting the one of the plurality of candidate paths that has the highest similarity for the first navigation solution.

8. A method for positioning a movable object in a site, the method comprising:
collecting sensor data from the a plurality of sensors;
obtaining one or more observations based on the collected sensor data, said one or more observations spatially distributed over the site;
retrieving a portion of the location-based service (LBS) features from a LBS feature map of the site, the LBS feature map stored in the memory and comprising a plurality of LBS features each associated with a location in the site; and
generating a first navigation solution for positioning the movable object at least based on the one or more observations and the retrieved LBS features, said first navigation solution comprising a determined navigation path of the movable object and parameters related to the motion of the movable object;
wherein the plurality of LBS features in the LBS feature map are spatially indexed.

9. The method of claim 8, wherein the LBS feature map comprises at least one of an image parametric model, an inertial measurement unit (IMU) error model, a motion dynamic constraint model, and a wireless data model.

10. The method of claim 8 further comprising:
obtaining one or more navigation conditions based on the one or more observations; and
wherein said retrieving the portion of the LBS features from the LBS feature map comprises:
determining the portion of the LBS features in the LBS feature map based on the one or more navigation conditions.

11. The method of claim 8 further comprising:
extracting a spatial structure of the site based on the observations;
simplifying the spatial structure into a skeleton, the skeleton being represented by a graph comprising a plurality of nodes and a plurality of links, each of the plurality of links connecting two of the plurality of nodes;
calculating a statistic distribution of the observations over the site;
adjusting the graph based on at least geographical relationships between the nodes and links and the statistic distribution of the observations;
fusing at least the adjusted spatial structure and the observation distribution for obtaining updated LBS features; and
associating the updated LBS features with respective locations for updating the LBS feature map.

12. The method of claim 11, wherein said adjusting the graph based on the at least geographical relationships between the nodes and links and the statistic distribution of the observations comprises at least one of:
merging two or more of the plurality of nodes in a first area of the site and removing the links therebetween if the number of samples of the observations in the first area is smaller than a first predefined number-threshold; and
adding one or more new nodes and links in a second area if the number of samples of the observations in the second area is greater than a second predefined number-threshold.

13. The method of claim 8, wherein said generating the first navigation solution comprises:
generating a second navigation solution and storing the second navigation solution in a buffer of the memory; and
if there exist more than one second navigation solutions in the buffer, applying a set of relative constraints to the more than one second navigation solutions for generating the first navigation solution for positioning the movable object; and
updating the LBS feature map using the first navigation solution.

14. The method of claim 8, wherein said generating the first navigation solution comprises:
determining a first navigation path of the movable object based on the observations, said first navigation path having a known starting point;
calculating a traversed distance of the first navigation path;
determining a plurality of candidate paths from the LBS feature map, each of the plurality of candidate paths starting from said known starting point and having a distance thereof such that the difference between the distance of each of the plurality of candidate paths and the traversed distance of the first navigation path is within a predefined distance-difference threshold;
calculating a similarity between the first navigation path and each of the plurality of candidate paths; and
selecting the one of the plurality of candidate paths that has the highest similarity for the first navigation solution.

15. One or more non-transitory computer-readable storage media comprising computer-executable instructions, the instructions, when executed, causing a processor to perform actions comprising:
collecting sensor data from the a plurality of sensors;
obtaining one or more observations based on the collected sensor data, said one or more observations spatially distributed over the site;
retrieving a portion of the location-based service (LBS) features from a LBS feature map of the site, the LBS feature map stored in the memory and comprising a plurality of LBS features each associated with a location in the site; and
generating a first navigation solution for positioning the movable object at least based on the one or more observations and the retrieved LBS features, said first navigation solution comprising a determined navigation path of the movable object and parameters related to the motion of the movable object;
wherein the plurality of LBS features in the LBS feature map are spatially indexed.

16. The one or more non-transitory computer-readable storage media of claim 15, wherein the LBS feature map comprises at least one of an image parametric model, an inertial measurement unit (IMU) error model, a motion dynamic constraint model, and a wireless data model.

17. The one or more non-transitory computer-readable storage media of claim 15, wherein the instructions, when executed, cause the processor to perform further actions comprising:
obtaining one or more navigation conditions based on the one or more observations; and
wherein said retrieving the portion of the LBS features from the LBS feature map comprises:
determining the portion of the LBS features in the LBS feature map based on the one or more navigation conditions.

18. The one or more non-transitory computer-readable storage media of claim 15, wherein the instructions, when executed, cause the processor to perform further actions comprising:
extracting a spatial structure of the site based on the observations;
simplifying the spatial structure into a skeleton, the skeleton being represented by a graph comprising a plurality of nodes and a plurality of links, each of the plurality of links connecting two of the plurality of nodes;
calculating a statistic distribution of the observations over the site;
adjusting the graph based on at least geographical relationships between the nodes and links and the statistic distribution of the observations;
fusing at least the adjusted spatial structure and the observation distribution for obtaining updated LBS features; and
associating the updated LBS features with respective locations for updating the LBS feature map.

19. The one or more non-transitory computer-readable storage media of claim 18, wherein said adjusting the graph based on the at least geographical relationships between the nodes and links and the statistic distribution of the observations comprises at least one of:
merging two or more of the plurality of nodes in a first area of the site and removing the links therebetween if the number of samples of the observations in the first area is smaller than a first predefined number-threshold; and
adding one or more new nodes and links in a second area if the number of samples of the observations in the second area is greater than a second predefined number-threshold.

20. The one or more non-transitory computer-readable storage media of claim 15, wherein said generating the first navigation solution comprises:
generating a second navigation solution and storing the second navigation solution in a buffer of the memory;
if there exist more than one second navigation solutions in the buffer, applying a set of relative constraints to the more than one second navigation solutions for generating the first navigation solution for positioning the movable object; and
updating the LBS feature map using the first navigation solution.

21. The one or more non-transitory computer-readable storage media of claim 15, wherein said generating the first navigation solution comprises:
determining a first navigation path of the movable object based on the observations, said first navigation path having a known starting point;
calculating a traversed distance of the first navigation path;
determining a plurality of candidate paths from the LBS feature map, each of the plurality of candidate paths starting from said known starting point and having a distance thereof such that the difference between the distance of each of the plurality of candidate paths and the traversed distance of the first navigation path is within a predefined distance-difference threshold;
calculating a similarity between the first navigation path and each of the plurality of candidate paths; and
selecting the one of the plurality of candidate paths that has the highest similarity for the first navigation solution.
